(19) United States
(12) Patent Application Publication
(10) Pub. No.: US 2013/0163086 A1
(43) Pub. Date: Jun. 27, 2013

(54) SYSTEMS AND METHODS FOR IMPROVING THE PERFORMANCE OF A PHOTOREFRACTIVE DEVICE BY UTILIZING ELECTROLYTES

(71) Applicants: Tao Gu, San Diego, CA (US); Weiping Lin, Carlsbad, CA (US); Wan-Yun Hsieh, San Diego, CA (US); Michiharu Yamamoto, Carlsbad, CA (US)

(72) Inventors: Tao Gu, San Diego, CA (US); Weiping Lin, Carlsbad, CA (US); Wan-Yun Hsieh, San Diego, CA (US); Michiharu Yamamoto, Carlsbad, CA (US)

(73) Assignee: NITTO DENKO CORPORATION, Osaka (JP)

(21) Appl. No.: 13/820,484

(22) PCT Filed: Aug. 31, 2011
(86) PCT No.: PCT/US11/50067

§ 371 Date: Mar. 1, 2013

Related U.S. Application Data
(60) Provisional application No. 61/379,542, filed on Sep. 2, 2010.

(51) Int. Cl. G02B 5/18; B32B 37/16

(52) U.S. Cl. CPC G02B 5/18; B32B 37/16
USPC 359/566; 359/558; 156/306.6

(57) ABSTRACT

A photorefractive device (100) and method of manufacture are disclosed. The device (100) comprises a layered structure in which one or more polymer layers (110) are interposed between a photorefractive material (106) and at least one transparent electrode layer (104). One or more electrolytes are dispersed into the one or more polymer layers (110). When a bias is applied to the device (100), the device (100) exhibits an increase in signal efficiency compared to a similar device without electrolyte. Both grating decay time and grating response time are greatly reduced by dispersing electrolytes into one or more polymer layers in the photorefractive device. The grating decay time can be adjusted by dispersing different kinds of the electrolytes and/or different concentration of the electrolytes, which can be fitted into all kinds of applications with different requirements for grating response and decay time.

### BACKGROUND OF THE INVENTION

1. Field of the Invention

The invention relates to methods for improving the properties of photorefractive materials and to utilizing multiple layers, at least one of which is a polymer layer comprising electrolytes, to improve the performance. Particularly, the grating diffraction efficiency, response time, and decay time of the photorefractive materials are improved.

2. Description of the Related Art

Photorefractivity is a phenomenon in which the refractive index of a material can be altered by changing the electric field within the material, such as by laser beam irradiation. The change of the refractive index is achieved by a series of steps, including: (1) charge generation by laser irradiation, (2) charge transport, resulting in the separation of positive and negative charges, (3) trapping of one type of charge (charge delocalization), (4) formation of a non-uniform internal electric field (space-charge field) as a result of charge delocalization, and (5) refractive index change induced by the non-uniform electric field. Therefore, good photorefractive properties can generally be seen in materials that combine good charge generation, good charge transport or photoconductivity, and good electro-optical activity.

Photorefractive materials have many promising applications, such as high-density optical data storage, dynamic holography, optical image processing, phase conjugated mirrors, optical computing, parallel optical logic, and pattern recognition. Originally, the photorefractive effect was found in a variety of inorganic electro-optical (EO) crystals, such as LiNbO₃. In these materials, the mechanism of the refractive index modulation by the internal space-charge field is based on a linear electro-optical effect. Usually inorganic electro-optical (EO) crystals do not require biased voltage for the photorefractive behavior.

In 1990 and 1991, the first organic photorefractive crystal and polymeric photorefractive materials were discovered and reported. Such materials are disclosed, for example, in U.S. Pat. No. 5,064,264, to Ducharme et al, the contents of which are hereby incorporated by reference. Organic photorefractive materials offer many advantages over the original inorganic photorefractive crystals, such as large optical non-linearities, low dielectric constants, low cost, light weight, structural flexibility, and ease of device fabrication. Other important characteristics that may be desirable, depending on the application, include long shelf life, optical quality, and thermal stability. These kinds of active organic polymers are emerging as key materials for advanced information and telecommunication technology.

In recent years, efforts have been made to optimize the properties of organic, and particularly polymeric, photorefractive materials. As mentioned above, good photorefractive properties depend upon good charge generation, good charge transport, also known as photoconductivity, and good electro-optical activity. Various studies have been performed to examine the selection and combination of the components that give rise to each of these features. The photoconductive capability is frequently provided by incorporating materials containing carbazole groups. Phenyl amine groups can also be used for the charge transport part of the material.

Particularly, several new organic photorefractive compositions which have better photorefractive performances, such as high diffraction efficiency, fast response time, and long phase stabilities, have been developed. For examples, see U.S. Pat. Nos. 6,809,156, 6,653,421, 6,646,107, 6,610,809 and U.S. Patent Application Publication No. 2004/0077794 (Nitto Denko Technical), all of which are hereby incorporated by reference. These patents and patent applications disclose methodologies and materials to make triphenyl diamine (TPD) type photorefractive compositions which show very fast response times and good gain coefficients.

Typically, a high biased voltage can be applied to photorefractive materials in order to obtain good photorefractive behavior. Recent efforts have been made to improve grating holding persistency. For example, WO 2008/091716 and U.S. Patent Application Publication No. 2009/0547336, both of which are hereby incorporated by reference in their entirety, disclose methodologies to utilize approximately half the biased voltage, advantageously resulting in a longer device lifetime by incorporating a polymer layer into the device. The incorporation of the polymer layer in those references improved devices for applications with long grating requirements because the polymer layer reduced the bias voltage, hold grating persistency and protected the devices from voltage breakdown.

With the development of improved laser writing techniques, there remains a need to improve grating response and grating decay times in photorefractive materials while, at the same time, inhibiting or preventing voltage breakdown.

### SUMMARY OF THE INVENTION

One embodiment provides a method for improving the performance of a photorefractive device comprising one or more transparent electrode layers and a photorefractive material. The method comprises interposing one or more polymer layers that comprises one or more electrolytes between the transparent electrode layer and the photorefractive material. In an embodiment, the method comprises interposing a first polymer layer between a first transparent electrode layer and the photorefractive material and interposing a second polymer layer between a second transparent electrode layer and the photorefractive material. As discussed further below, the amount of electrolyte dispersed in any polymer layer can vary.

Another embodiment of the present disclosure provides a photorefractive device. The photorefractive device can be made according to the methods described herein. In an embodiment, the photorefractive device comprises a photorefractive material, a first electrode layer, and at least one polymer layer interposed between the first electrode layer and the photorefractive material. Preferably, one or more electrolytes is dispersed in said one or more polymer layers.

In an embodiment, the photorefractive device comprises a first polymer layer and a second polymer layer, wherein the first electrode layer and the second electrode layer are positioned on opposite sides of the photorefractive material, In an embodiment, the first polymer layer is interposed between the first electrode layer and the photorefractive material. In an embodiment, the second polymer layer is interposed between the second electrode layer and the photorefractive material. In an embodiment, one or more electrolytes are dispersed in at least one of the first polymer layer and/or the second polymer layer. In an embodiment, the photorefractive device comprises a plurality of substrate layers, a plurality of electrode layers interposed between the substrate layers, a plurality of polymer layers interposed between the electrode layers, and a photorefractive layer interposed between the polymer layers. Additional layers can be further incorporated, if desired.

In an embodiment, the grating response time and/or grating decay time of the photorefractive device is reduced when measured using a laser beam after incorporating the one or more polymer layers comprising one or more electrolytes, relative to a similar photorefractive device containing at least one transparent electrode layer and a photorefractive material with a polymer layer interposed there between, but the polymer being without electrolytes dispersed therein.

In an embodiment, the grating diffraction efficiency of the photorefractive device is increased when measured using a laser beam after incorporating the one or more polymer layers comprising one or more electrolytes, relative to a similar photorefractive device comprising at least one transparent electrode layer and a photorefractive material with a polymer layer interposed there between, but the polymer being without electrolytes dispersed therein.

In an embodiment, the device comprises first and second electrode layers positioned on the opposite sides of the photorefractive material, a first polymer layer interposed between the first electrode layer and the photorefractive material, and a second polymer layer interposed between the second electrode layer and the photorefractive material. In an embodiment, one or more electrolytes are dispersed in the first polymer layer. In an embodiment, one or more electrolytes are dispersed in the second polymer layer. In an embodiment, one or more electrolytes are dispersed in both the first polymer layer and the second polymer layer.

In an embodiment, the polymer layer is formed from a substance selected from the group consisting of polymethyl methacrylate, polyimide, amorphous polycarbonate, siloxane sol-gel, and combinations thereof. In some embodiments, the polymer layer comprises amorphous polycarbonate.

The one or more electrolytes dispersed in the one or more polymer layers can vary. In an embodiment, the electrolytes comprise an organic salt. In an embodiment, the electrolytes are selected from the group consisting of ammonium salts, heterocyclic ammonium salts, phosphonium salts, acridinium salts, and combinations thereof.

The amount of electrolytes dispersed within the polymer can vary. In an embodiment, the amount of electrolytes dispersed in a polymer layer is in the range of about 0.01% to about 10% by weight of the polymer. In an embodiment, the amount of electrolytes dispersed in a polymer layer is in the range of about 0.05% to about 5% by weight of the polymer. In an embodiment, the amount of electrolytes dispersed in a polymer layer is in the range of about 0.1% to about 2% by weight of the polymer. In an embodiment, the amount of electrolytes dispersed in a polymer layer is in the range of about 0.1% to about 1% by weight of the polymer. In an embodiment, the amount of electrolytes dispersed in a polymer layer is in the range of about 0.5% to about 2% by weight of the polymer.

The total combined thickness of the one or more polymer layers can vary over a wide range in the method of improving a photorefractive device. In an embodiment, the total combined thickness of the one or more polymer layers is from about 1 μm to about 80 μm. In an embodiment, the total combined thickness of the one or more polymer layers is from about 2 μm to about 40 μm. In an embodiment, the total combined thickness of the one or more polymer layers is from about 2 μm to about 30 μm. In an embodiment, the total combined thickness of the one or more polymer layers is from about 2 μm to about 20 μm.

Where more than one polymer layer is used in the method for improving the photorefractive device, the thickness of each of the polymer layers can be independently selected. For example, each individual polymer layer can have a thickness from about 1 μm to about 40 μm. In an embodiment, each individual polymer layer has a thickness from about 2 μm to about 20 μm. In an embodiment, each individual polymer layer has a thickness from about 10 μm to about 20 μm. In an embodiment, each individual polymer layer has a thickness from about 2 μm to about 10 μm. In an embodiment, each individual polymer layer has a thickness from about 15 μm to about 20 μm.

In an embodiment, the polymer layer has a relative dielectric constant from about 2 to about 15. In an embodiment, the polymer layer has a relative dielectric constant from about 2 to about 4.5. In an embodiment, the refractive index of the polymer layer is from about 1.5 to about 1.7.

In an embodiment, the electrodes of the device comprise conducting films independently selected from the group consisting of metal oxides, metals, and organic films, with an optical density less than about 0.2. In an embodiment, the electrodes each individually comprise one of indium tin oxide, tin oxide, zinc oxide, polythiophene, gold, aluminum, polyaniline, and combinations thereof.

The photorefractive material can comprise a polymer that is organic or inorganic in the methods for improving the performance of a photorefractive device. In an embodiment, the photorefractive material comprises organic or inorganic polymers exhibiting photorefractive behavior and possessing a refractive index of about 1.7.

In an embodiment, the photorefractive device comprises a substrate attached to the first electrode layer at the side opposite the polymer layer. In an embodiment, the substrate of the photorefractive device comprises at least one of soda lime glass, silica glass, borosilicate glass, gallium nitride, gallium arsenide, sapphire, quartz glass, polyethylene terephthalate, and polycarbonate. In some embodiments, the substrate comprises a material possessing an index of refraction less than about 1.5.

The grating response time (e.g. time of grating increase to 1/e of the maximum value) has been measured in the photorefractive devices described herein. In an embodiment, the grating response time of the photorefractive device is 10 seconds or less when measured by a laser beam. In an embodiment, the grating response time of the photorefractive device is 3 seconds or less when measured by a laser beam.

The grating decay time (e.g. time of grating drop to 1/e of the initial value) has been measured in the photorefractive devices described herein. In an embodiment, the grating decay time of the photorefractive device is 10 seconds or less when measured by a laser beam. In an embodiment, the grating decay of the photorefractive device is 3 seconds or less when measured by a laser beam.

The grating diffraction efficiency of the photorefractive device comprising a polymer layer with electrolytes can be increased compared to a photorefractive device without electrolytes in a polymer layer, when measured by a laser beam.

### BRIEF DESCRIPTION OF THE DRAWINGS

FIG. 1A illustrates an embodiment in which one polymer layer is interposed between an electrode layer and a photorefractive material on one side of the photorefractive material.

FIG. 1B illustrates an embodiment in which two polymer layers are interposed between an electrode layer and a photorefractive material on both sides of the photorefractive material.

FIG. 2A illustrates an embodiment in which one polymer layer is interposed between an electrode layer and a photorefractive material on one side of the photorefractive material.

FIG. 2B illustrates an embodiment in which two polymer layers are interposed between an electrode layer and a photorefractive material on both sides of the photorefractive material.

FIGS. 3A and 3B provide chemical structures for exemplary chromophores according to the general formula (VII).

FIG. 4 provides chemical structures for exemplary chromophores according to the general formula (VIII).

### DETAILED DESCRIPTION OF THE PREFERRED EMBODIMENT

The present disclosure relates to systems and methods for improving the performance of photorefractive devices comprising at least one transparent electrode layer and a photorefractive material. One or more polymer layers are interposed between the transparent electrode layers and the photorefractive material, wherein one or more electrolytes are dispersed among the one or more polymer layers. Advantageously, as discussed in greater detail below, this design lowers the biased voltage required to operate the device, improves the response time and decay time, and aids in prevention of the device from breaking down. Photorefractive devices based upon this design may be used for a variety of purposes including, but not limited to, holographic image recording materials and devices.

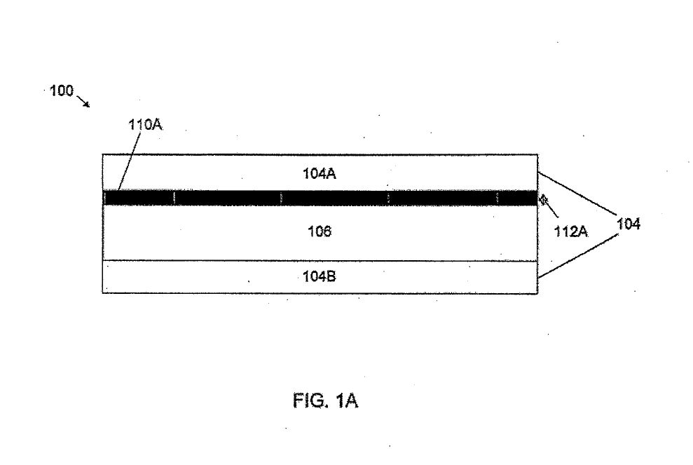

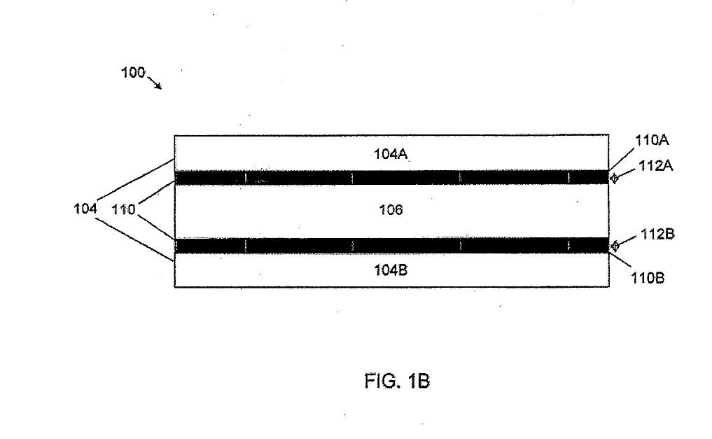

FIGS. 1A and 1B illustrate a portion of one embodiment of a photorefractive device 100, comprising one or more electrode layers 104 and a photorefractive material 106. In one embodiment, first and second electrode layers 104A, 104B are positioned on opposite sides of the photorefractive material 106. The first and second electrode layers 104A, 104B may comprise the same materials or different materials, as discussed below.

The photorefractive layer can have a variety of thickness values for use in a photorefractive device. In an embodiment, the photorefractive layer is about 10 to about 200 μm thick. In an embodiment, the photorefractive layer is about 25 to about 100 μm thick. Such ranges of thickness allow for the photorefractive material to give good grating behavior.

One or more polymer layers 110 are also interposed between the electrode layers 104A, 104B and the photorefractive material 106, and one or more electrolytes are dispersed among the one or more polymer layers. The manner in which the electrolytes are dispersed within the polymer layer can vary. For example, the electrolytes can be uniformly dispersed within the polymer layer. In an embodiment, the electrolytes are dispersed in a gradient fashion within the polymer layer. In one embodiment, illustrated in FIG. 1A, a first polymer layer 110A is interposed between the first electrode layer 104A and the photorefractive material 106. In an alternative embodiment, illustrated in FIG. 1B, the embodiment of FIG. 1A is modified such that a second polymer layer 110B is interposed between the second electrode layer 104B and the photorefractive material 106. The first and second polymer layers 110A, 110B may comprise the same material or different materials, as discussed below. For example, the type of polymer can be the same or different. Furthermore, the type of electrolyte, if incorporated into the polymer, can be the same or different. The thicknesses of each of the polymer layers can be independently selected.

In one embodiment, the polymer layers 110 are applied to the one or more electrode layers 104 by techniques known to those skilled in the art, including, but not limited to, spin coating and solvent casting. The photorefractive material 106 is subsequently mounted to the polymer layer modified electrodes 104. Preferably, one or more of the polymer layers 110 comprise electrolytes.

In one embodiment, the one or more polymer layers 110 comprise a single layer having selected thicknesses 112A, 112B. In an alternative embodiment, the polymer layer 110 comprises more than one layer, where the total thickness 112A, 112B of all the layers of the polymer layer 110 is approximately equal to the selected thickness 112A, 112B. The selected thicknesses 112A, 112B may be independently selected, as necessary. In an embodiment, the selected thicknesses 112A, 112B of the polymer layers 110 range from about 2 μm to 40 μm. In an embodiment, the selected thicknesses 112A, 112B of the polymer layers 110 range from about 2 μm to about 30 μm. In an embodiment, the selected thicknesses 112 range from about 2 μm to about 20 μm. In an embodiment, the selected thicknesses 112 range from about 20 μm to about 40 μm. In one non-limiting example, the selected thicknesses 112A, 112B of the polymer layers 110 are each approximately 20 μm.

When more than one polymer layer is present, not all of the polymer layers need to comprise electrolytes. In an embodiment, one polymer layer comprises one or more electrolytes. In an embodiment, two polymer layers comprise one or more electrolytes. In an embodiment, more than two polymer layers comprise one or more electrolytes.

In one embodiment, the polymer layer 110 further comprises a polymer exhibiting a low dielectric constant. Preferably, the relative dielectric constant of the polymer layer 110 ranges from about 2 to about 15, and more preferably ranges from about 2 to about 4.5. The refractive index of the polymer layers 110 can be from about 1.5 to about 1.7. In an embodiment, the one or more polymer layers are not, themselves, photorefractive. Non-limiting examples of materials comprising the polymer layers 110 may include, but are not limited to, polymethyl methacrylate (PMMA), polyimide, amorphous polycarbonate (APC), and siloxane sol-gel. These materials can be used singly or in combination. For example, the one or more polymer layers 110 can comprise any single polymer, a mixture of two or more polymers, multiple layers that each comprise a different polymer, or combinations thereof.

The amount of electrolytes dispersed within a polymer layer can vary. In an embodiment, the amount of electrolytes dispersed in a polymer layer is in the range of about 0.01% to about 10% by weight of the polymer. In an embodiment, the amount of electrolytes dispersed in a polymer layer is in the range of about 0.05% to about 5% by weight of the polymer. In an embodiment, the amount of electrolytes dispersed in a polymer layer is in the range of about 0.1% to about 2% by weight of the polymer. In an embodiment, the amount of electrolytes dispersed in a polymer layer is in the range of about 0.1% to about 1% by weight of the polymer. In an embodiment, the amount of electrolytes dispersed in a polymer layer is in the range of about 0.5% to about 2% by weight of the polymer.

Various types of electrolytes can be used. An electrolyte contains free ions that make it electrically conductive. The inclusion of electrolytes in the polymer layer provides free ions in the photorefractive device, thus allowing for further charge transport properties in the device. In an embodiment, one or more electrolytes comprise a salt. In an embodiment, one or more electrolytes comprise an organic salt. In an embodiment, the salt comprises one or more salt selected from the group consisting of an ammonium salt, such as a heterocyclic ammonium salt, an acridinium salt, a bipyridinium salts, a choline salt, a dequalinium salt, an imidazolium salt, morpholinium salt, a phosphonium salt, a piperidinium salt, a piperazinium salt, a pyrazolium salt, a pyridinium salt, a pyrrolidinium salt, a sulfonium salt, a thiazolium salt, and combinations thereof.

In an embodiment, one or more electrolytes are selected from the group consisting of ammonium salts, heterocyclic ammonium salts, phosphonium salts, acridinium salts, and combinations thereof. Alkylammonium salts, including monoalkyl-, dialkyl-, trialkyl-, and tetraalkylammonium salts are particularly preferred. Such salts, e.g. tetraalkylammonium salts, are very suitable because of excellent solubility characteristics in most organic solvents.

In an embodiment, the salt comprises a cation and an anion. Several different combinations of cations and anions can be used. In an embodiment, the cation comprises an ammonium or thio salt. In an embodiment, the cation is selected from the group consisting of the following structures:

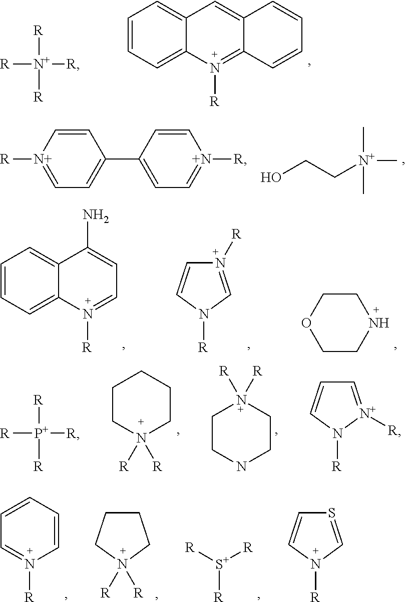

wherein R in each of the structures above is independently selected from the group consisting of hydrogen, linear and branched C₁-C₁₀ alkyl, and C₄-C₁₀ aryl.

Several different anions may also be used. In an embodiment, the anion is selected from the group consisting of acetate, benzoate, bisulfate, bis-trifluoromethanesulfonimidate, bromide, chloride, cyanate, cyanide, dicyanamide, dihydrogen phosphate, difluorotriphenylsilicate, difluorotriphenylstannate, dimethyl phosphate, dibutyl phosphate, ethyl sulfate, fluorosulfate, formate, glutaconaldehyde enolate, heptadecafluorooctanesulfonate, hexafluorophosphate, hydrogen sulfate, hydrogen carbonate, heptadecafluorooctanesulfonic, hypophosphite, iodide, methanesulfonate, methyl sulfate, nitrate, methyl sulfate, nonafluorobutanesulfonate, p-toluenesulfonate, perchlorate, phosphate monobasic, succinimide, sulfamate, tetrabutylborate, tetrafluoroborate, tetraphenylborate, thiocyanate, thiophenolate, thiosalicylate, tribromide, trifluoromethanesulfonate, triiodide, tris(trifluoromethylsulfonyl)methide, and combinations thereof. In an embodiment, the anions are selected from the group consisting of hexafluorophosphate, bromide, perchlorate, benzoate.

Some non-limiting examples of useful electrolytes include tetrabutylammonium fluorosulfate, tetraethylammonium bromide, tetraethylammonium chloride, tetraethylammonium tetrafluoroborate, tetraethylammonium hexafluorophosphate, tetraethylammonium iodide, tetraethylammonium perchlorate, tetraethylammonium trifluoromethanesulfonate, tetraethylammonium p-toluenesulfonate, tetrabutylammonium acetate, tetrabutylammonium bromide, tetrabutylammonium benzoate, tetrabutylammonium bis-trifluoromethanesulfonimidate, tetrabutylammonium hexafluorophosphate, tetrabutylammonium perchlorate, tetrabutylammonium trifluoromethanesulfonate, tetrabutylammonium tetrafluoroborate, tetrabutylammonium tetraphenylborate, tetrabutylammonium iodide, tetrabutylammonium nitrate, tetrabutylammonium p-toluenesulfonate, tetrabutylphosphonium hexafluorophosphate, tetrabutylphosphonium tetrafluoroborate, tetraethyl ammonium benzoate, tetraethylammonium bistrifluoromethanesulfonimidate, tetramethylammonium bromide, tetramethylammonium chloride, tetramethylammonium nitrate, tetrapentylammonium perchlorate, and tetrapropylammonium bromide.

In one embodiment, the electrode 104 comprises a transparent electrode 104. The transparent electrode 104 is further configured as a conducting film. The material comprising the conducting film may be independently selected from the group consisting of metal oxides, metals, and organic films with an optical density less than about 0.2. Non-limiting examples of transparent electrodes 104 include indium tin oxide (ITO), tin oxide, zinc oxide, polythiophene, gold, aluminum, polyaniline, and combinations thereof. Preferably, the transparent electrodes 104 are independently selected from the list consisting of indium tin oxide and zinc oxide.

Dispersing electrolytes in the polymer layer improves the grating response time of the material. In an embodiment, the grating response time of the photorefractive device is 60 seconds or less when measured by a laser beam. In an embodiment, the grating response time of the photorefractive device is 30 seconds or less when measured by a laser beam. In an embodiment, the grating response time of the photorefractive device is 20 seconds or less when measured by a laser beam. In an embodiment, the grating response time of the photorefractive device is 10 seconds or less when measured by a laser beam. In an embodiment, the grating response time of the photorefractive device is 3 seconds or less when measured by a laser beam. In an embodiment, the grating response time of the photorefractive device is 1 second or less when measured by a laser beam. In an embodiment, the grating response time of the photorefractive device is 0.5 seconds or less when measured by a laser beam. In an embodiment, the grating response time of the photorefractive device is 0.2 seconds or less when measured by a laser beam.

Dispersing electrolytes in the polymer layer also improves the grating decay time of the material. In an embodiment, the grating decay time of the photorefractive device is 60 seconds or less when measured by a laser beam. In an embodiment, the grating decay time of the photorefractive device is 300 seconds or less when measured by a laser beam. In an embodiment, the grating decay time of the photorefractive device is 20 seconds or less when measured by a laser beam. In an embodiment, the grating decay of the photorefractive device is 10 seconds or less when measured by a laser beam. In an embodiment, the grating decay of the photorefractive device is 3 seconds or less when measured by a laser beam. In an embodiment, the grating decay time can be adjusted by dispersing different electrolytes in different concentration in the polymer layer. In one embodiment, the grating decay time of the photorefractive device comprising a polymer layer with electrolytes is lessened by at least three times compared to a photorefractive device without electrolytes in a polymer layer, when measured by a laser beam. In one embodiment, the grating decay time of the photorefractive device comprising a polymer layer with electrolytes is lessened by at least five times compared to a photorefractive device without electrolytes in a polymer layer, when measured by a laser beam. In one embodiment, the grating decay time of the photorefractive device comprising a polymer layer with electrolytes is lessened by at least ten times compared to a photorefractive device without electrolytes in a polymer layer, when measured by a laser beam. The polymer layer can be fitted into all kinds of applications with different requirements.

In one embodiment, the grating diffraction efficiency of the photorefractive device comprising a polymer layer with electrolytes is increased at least two times stronger compared to a photorefractive device without electrolytes in a polymer layer, when measured by a laser beam. In one embodiment, the grating diffraction efficiency of the photorefractive device comprising a polymer layer with electrolytes is increased at least five times stronger compared to a photorefractive device without electrolytes in a polymer layer, when measured by a laser beam. In one embodiment, the grating diffraction efficiency of the photorefractive device comprising a polymer layer with electrolytes is increased at least ten times stronger compared to a photorefractive device without electrolytes in a polymer layer, when measured by a laser beam.

In one embodiment, the photorefractive material comprises an organic or inorganic polymer exhibiting photorefractive behavior. In an embodiment, the polymer possesses a refractive index of approximately 1.7. Preferred non-limiting examples include photorefractive materials comprising a polymer matrix with at least one of a repeat unit including a moiety having photoconductive or charge transport ability and a repeat unit including a moiety having non-linear optical ability, as discussed in greater detail below. Optionally, the material may further comprise other components, such as repeat units including another moiety having non-linear optical ability, as well as sensitizers and plasticizers, as described in U.S. Pat. No. 6,610,809 to Nitto Denko Corporation and hereby incorporated by reference. One or both of the photoconductive and non-linear optical components are incorporated as functional groups into the polymer structure, typically as side groups.

The group that provides the charge transport functionality may be any group known in the art to provide such capability. If this group is to be attached to the polymer matrix as a side chain, then the group should be capable of incorporation into a monomer that can be polymerized to form the polymer matrix of the photorefractive composition.

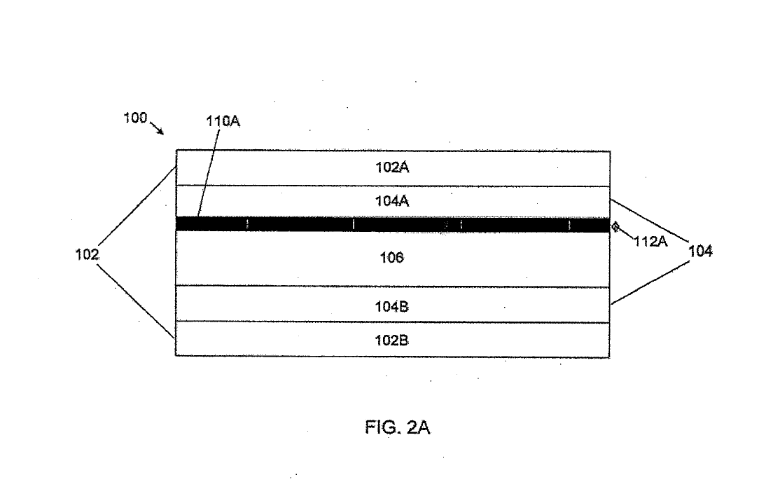

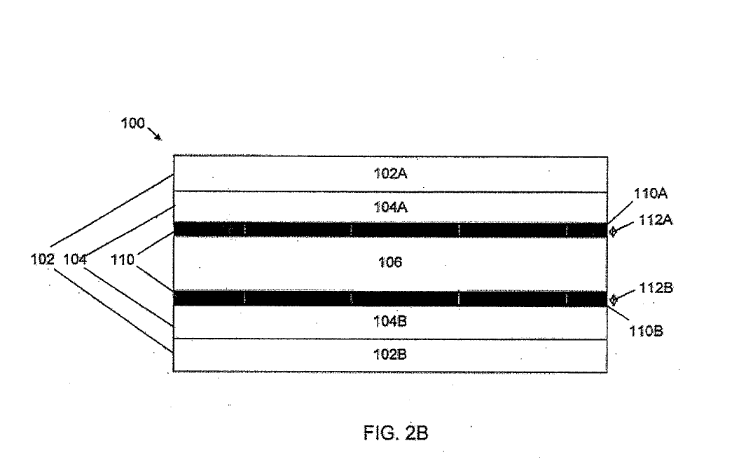

One embodiment of the photorefractive device 100 is illustrated in FIG. 2A-2B. The photorefractive device 100 comprises a plurality of substrate layers 102, a plurality of electrode layers 104 interposed between the substrate layers 102, a plurality of polymer layers 110 interposed between the electrode layers 104, and a photorefractive layer 106 interposed between the polymer layers 110. One or more electrolytes may be dispersed among one or more of the polymer layers.

In one embodiment, a pair of electrode layers 104A, 104B is interposed between a pair of substrate layers 102A, 102B, and the layer of photorefractive material 106 is interposed between the pair of electrode layers 104A, 104B. In an embodiment, illustrated in FIG. 2A, a first polymer layer 110A is positioned between the first electrode layer 104A and the photorefractive material 106. In an alternative embodiment, illustrated in FIG. 2B, the embodiment of FIG. 2A is modified such that a second polymer layer 110B is interposed between the second electrode layer 104B and the photorefractive material 106. As discussed above, the first and second polymer layers 110A, 110B can comprise the same material or different materials. Furthermore, the first polymer layer may comprise one or more electrolytes and the second polymer layer may comprise one or more electrolytes. The selection of which electrolyte(s) is incorporated into which polymer layer, including whether they are incorporated at all, may be made independently.

Non-limiting examples of the substrate layers 102 include soda lime glass, silica glass, borosilicate glass, gallium nitride, gallium arsenide, sapphire, quartz glass, polyethylene terephthalate, and polycarbonate. Preferably the substrate 102 comprises a material with a refractive index of 1.5 or less.

Non-limiting examples of the photoconductive, or charge transport, groups are illustrated below. In one embodiment, the photoconductive groups comprise phenyl amine derivatives, such as carbazoles and di- and tri-phenyl diamines. In a preferred embodiment, the moiety that provides the photoconductive functionality is chosen from the group of phenyl amine derivates consisting of the following side chain Structures (i), (ii) and (iii):

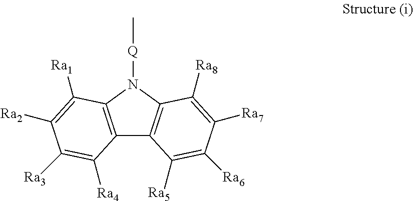

wherein Q represents an alkylene group comprising 1 to 10 carbon atoms with or without a hetero atom and Ra₁-Ra₈ are each independently selected from the group consisting of a hydrogen atom, a linear alkyl group with up to 10 carbons, a branched alkyl group with up to 10 carbons, and an aromatic group with up to 10 carbons;

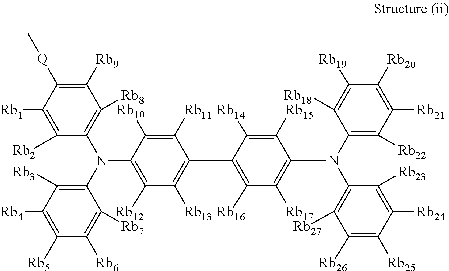

wherein Q represents an alkylene group comprising 1 to 10 carbon atoms with or without a hetero atom and Rb₁-Rb₂₇ are each independently selected from the group consisting of a hydrogen atom, a linear alkyl group with up to 10 carbons, a branched alkyl group with up to 10 carbons, and an aromatic group with up to 10 carbons;

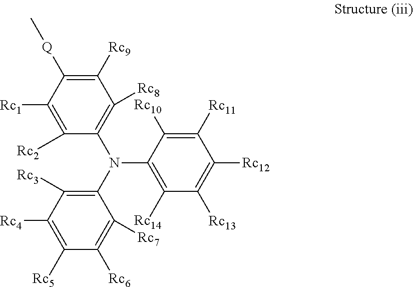

wherein Q represents an alkylene group comprising 1 to 10 carbon atoms with or without a hetero atom and Rc₁-Rc₁₄ are each independently selected from the group consisting of a hydrogen atom, a linear alkyl group with up to 10 carbons, a branched alkyl group with up to 10 carbons, and an aromatic group with up to 10 carbons.

The chromophore, or group that provides the non-linear optical functionality may be any group known in the art to provide such capability. If this group is to be attached to the polymer matrix as a side chain, then the group, or a precursor of the group, should be capable of incorporation into a monomer that can be polymerized to form the polymer matrix of the composition.

In an embodiment, when the chromophore is attached to the polymer matrix as a side chain, the chromophore side chain is represented by Structure (0):

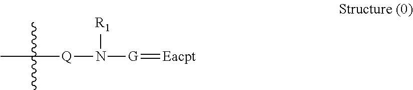

wherein Q represents an alkylene group comprising 1 to 10 carbon atoms with or without a hetero atom such as oxygen or sulfur and preferably Q is an alkylene group represented by (CH₂)ₚ where p is between about 2 and 6. R₁ is selected from the group consisting of a hydrogen atom, a linear alkyl group with up to 10 carbons, a branched alkyl group with up to 10 carbons, and an aromatic group with up to 10 carbons and preferably R₁ is an alkyl group selected from methyl, ethyl, propyl, butyl, pentyl and hexyl. G is a group having a bridge of π-conjugated bond. Eacpt is an electron acceptor group. Preferably Q is selected from the group consisting of ethylene, propylene, butylene, pentylene, hexylene, and heptylene.

In this context, the term “a bridge of π-conjugated bond” refers to a molecular fragment that connects two or more chemical groups by π-conjugated bond. A π-conjugated bond contains covalent bonds between atoms that have 6 bonds and r bonds formed between two atoms by overlap of their atomic orbits (s+p hybrid atomic orbits for 6 bonds; p atomic orbits for π bonds).

The term “electron acceptor” refers to a group of atoms with a high electron affinity that can be bonded to a π-conjugated bridge. Exemplary acceptors, in order of increasing strength, are: C(O)NR²<C(O)NHR<C(O)NH₂<C(O)OR<C(O)OH<C(O)R<C(O)H<CN<S(O)₂R<NO₂, wherein R and R₂ are each independently selected from the group consisting of a hydrogen atom, a linear alkyl group with up to 10 carbons, a branched alkyl group with up to 10 carbons, and an aromatic group with up to 10 carbons

As typical exemplary electron acceptor groups, functional groups which are described in U.S. Pat. No. 6,267,913, hereby incorporated by reference, can be used. At least a portion of these electron acceptor groups are shown in the structures below. The symbol “‡” in the chemical structures below specifies an atom of attachment to another chemical group and indicates that the structure is missing a hydrogen that would normally be implied by the structure in the absence of the “‡”:

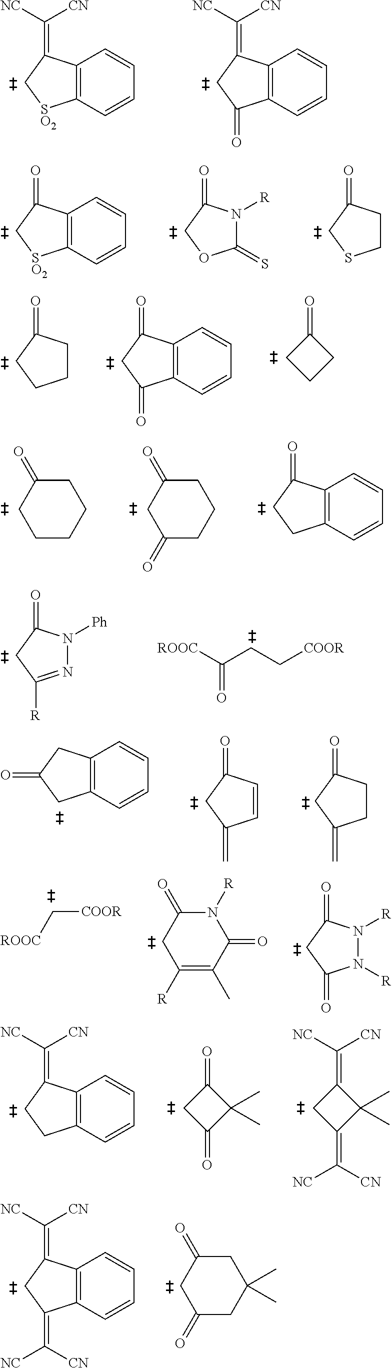

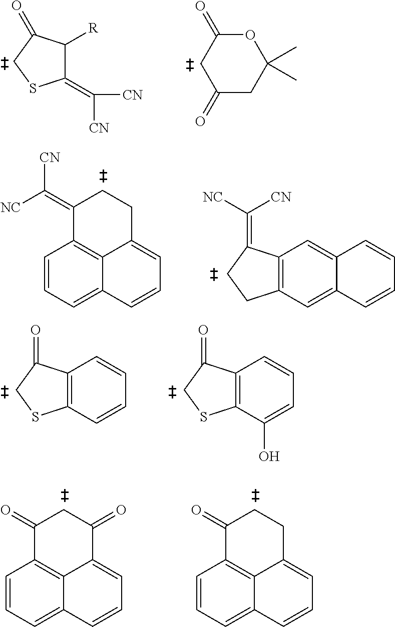

wherein R is selected from the group consisting of a hydrogen atom, a linear alkyl group with up to 10 carbons, a branched alkyl group with up to 10 carbons, and an aromatic group with up to 10 carbons.

Most preferably, the moiety that provides the non-linear optical functionality is such a case that G in Structure (0) is represented by a structure selected from the group consisting of the Structures (iv) and (v):

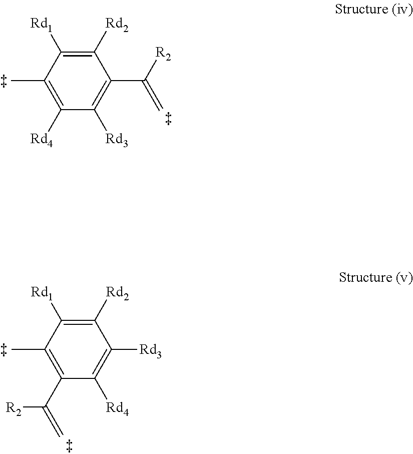

wherein, in both structures (iv) and (v), Rd₁-Rd₄ are each independently selected from the group consisting of a hydrogen atom, a linear alkyl group with up to 10 carbons, a branched alkyl group with up to 10 carbons, and an aromatic group with up to 10 carbons, and preferably Rd₁-Rd₄ are all hydrogen. R₂ is selected from the group consisting of a hydrogen atom, a linear alkyl group with up to 10 carbons, a branched alkyl group with up to 10 carbons, and an aromatic group with up to 10 carbons.

In an embodiment, Eacpt in Structure (0) is ═O or an electron acceptor group represented by a structure selected from the group consisting of the structures:

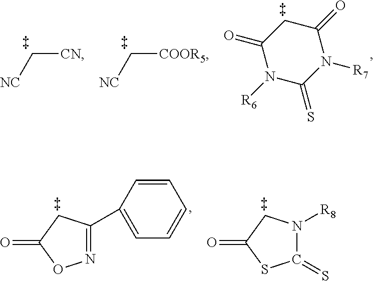

wherein R₅, R₆, R₇ and R₈ are each independently selected from the group consisting of a hydrogen atom, a linear alkyl group with up to 10 carbons, a branched alkyl group with up to 10 carbons, and an aromatic group with up to 10 carbons.

Preferred chromophore groups are aniline-type groups or dehydronaphtyl amine groups.

Various types of chromophores may be used. For example, the chromophore need not be incorporated into the polymer matrix by covalent side chain bonding. In some embodiments, the chromophore is represented by formula (IIb):

D-PiC-A (IIb)

wherein D is an electron donor group; PiC is a π-conjugated group; and A is an electron acceptor group.

The term “electron donor” is defined as a group with low electron affinity when compared to the electron affinity of A. Non-limiting examples of electron donor include amino (NRz₁Rz₂), methyl (CH₃), oxy (ORz₁), phosphino (PRz₁Rz₂), silicate (SiRz₁), and thio (SRz₁), and Rz₁ and Rz₂ are organic substituents independently selected from alkenyls, alkyls, alkynyls, aryls, cycloalkenyls, cycloalkyls, and heteroaryls. In an embodiment, a heteroaryl has at least one heteroatom selected from O and S.

The term “π-conjugated group,” “PiC” in formula (IIb) is independent of the selection of “G” in Structure (0). In some embodiments, suitable π-conjugated groups for PiC include at least one of the following groups: aromatics and condensed aromatics, polyenes, polyynes, quinomethides, and corresponding heteroatom substitutions thereof (e.g. furan, pyridine, pyrrole, and thiophene). In some embodiments, suitable π-conjugated groups for PiC include at least one heteroatom replacement of a carbon in a C═C or C≡C bond and combinations thereof, with or without substitutions. In some embodiments, the suitable π-conjugated groups include no more than two of the preceding groups described in this paragraph. Further, said group or groups may be substituted with a carbocyclic or heterocyclic ring, condensed or appended to the π-conjugated group. Non-limiting examples of π-conjugated groups for PiC in formula (IIb) include:

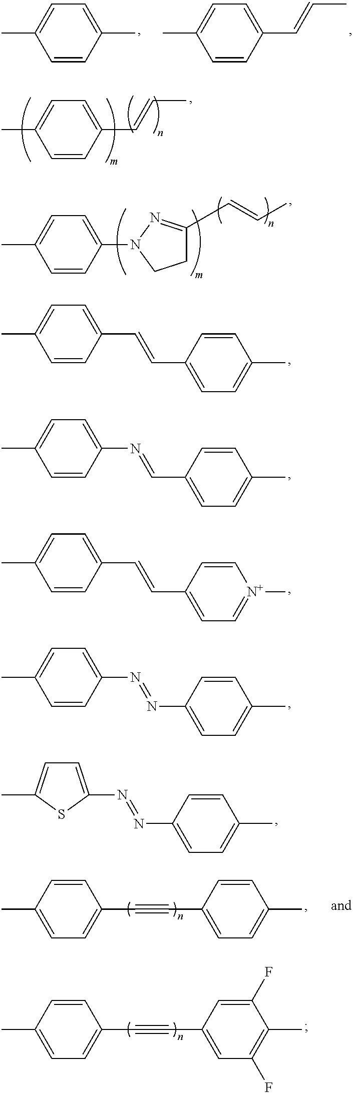

wherein m and n are each independently integers of 2 or less.

The term “electron acceptor” is defined above in formula (IIb) is independent of the selection of “Eacpt” in Structure (0). Additionally, “A” is further defined in this instance as an electron acceptor group with high electron affinity when compared to the electron affinity of D. In some embodiments, A is selected from, but not limited to the following: amide; cyano; ester; formyl; ketone; nitro; nitroso; sulphone; sulphoxide; sulphonate ester; sulphonamide; phosphine oxide; phosphonate; N-pyridinium; hetero-substitutions in B; variants thereof; and other positively charged quaternary salts. In some embodiments, A is selected from the group consisting of: NO₂, CN, C═C(CN)₂, CF₃, F, Cl, Br, I, S(═O)₂CₙF₂ₙ₊₁, S(CₙF₂ₙ₊₁)=NSO₂CF₃; wherein n is an integer from 1 to 10.

Preferably, the chromophore can configure the composition to be sensitive to multiple light wavelengths in the visible spectrum. In some embodiments, the chromophore is represented by formula (III):

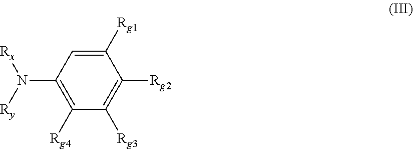

wherein Rₓ and R_{y} in formula (III) together with the nitrogen to which they are attached form a cyclic C₄-C₉ ring or Rₓ and R_{y} in formula (III) are each independently selected from a C₁-C₆ alkyl group or a C₄-C₁₀ aryl group; R_{g1}-R_{g4} in formula (III) are each independently selected from hydrogen or CN; and at least one of R_{g1}-R_{g4} in formula (III) is CN. In an embodiment, at least two of R_{g1}-R_{g4} in formula (III) are CN. In an embodiment, Rₓ and R_{y} in formula (III) together with the nitrogen to which they are attached form a cyclic C₅-C₈ ring.

In some embodiments, the chromophore of formula (III) is represented by formula (IIIa):

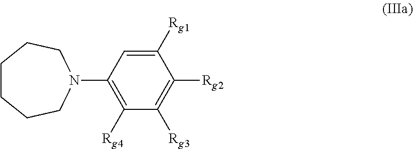

wherein R_{g1}-R_{g4} in formula (Ma) are each independently selected from hydrogen or CN, and at least one of R_{g1}—Ro in formula (Ma) is CN. In an embodiment, at least two of R_{g1}-R_{g4} in formula (Ma) are CN. In an embodiment, the chromophore of formula (Ma) is selected from one of the following compounds.

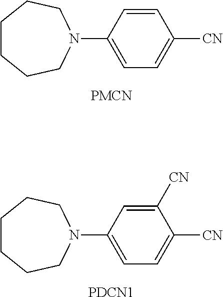

In some embodiments, the chromophore is represented by formula (IV):

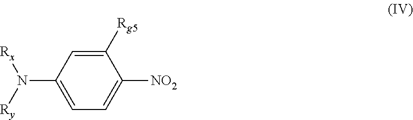

wherein Rₓ and R_{y} in formula (IV) together with the nitrogen to which they are attached form a cyclic C₄-C₉ ring or Rₓ and R_{y} in formula (IV) are each independently selected from a C₁-C₆ alkyl group or a C₄-C₁₀ aryl group; and R_{g5} in formula (IV) is C₁-C₆ alkyl. In an embodiment, Rₓ and R_{y} in formula (IV) together with the nitrogen to which they are attached form a cyclic C₅-C₈ ring.

In some embodiments, the chromophore is represented by formula (V):

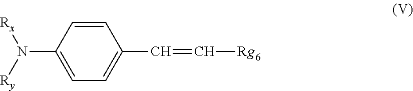

wherein Rₓ and R_{y} in formula (V) together with the nitrogen to which they are attached form a cyclic C₄-C₉ ring or Rₓ and R_{y} in formula (V) are each independently selected from a C₁-C₆ alkyl group or a C₄-C₁₀ aryl group; wherein R_{g6} in formula (V) is selected from CN or COOR, wherein R in formula (V) is hydrogen or a C₁-C₆ alkyl. Both the cis- and trans-isomers of formula (V) can be used. In an embodiment, the chromophore of formula (V) is a cis-isomer. In an embodiment, the chromophore of formula (V) is a trans-isomer. In an embodiment, Rₓ and R_{y} in formula (V) together with the nitrogen to which they are attached form a cyclic C₅-C₈ ring.

In some embodiments, the chromophore of formula (V) is represented by formula (Va):

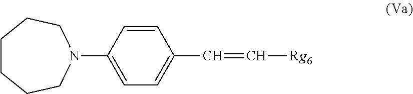

wherein R_{g6} in formula (Va) is selected from CN or COOR, wherein R in formula (Va) is hydrogen or a C₁-C₆ alkyl. Both the cis- and trans-isomers of formula (Va) can be used. In an embodiment, the chromophore of formula (Va) is a cis-isomer. In an embodiment, the chromophore of formula (Va) is a trans-isomer. In an embodiment, the chromophore of formula (Va) is selected from one of the following compounds.

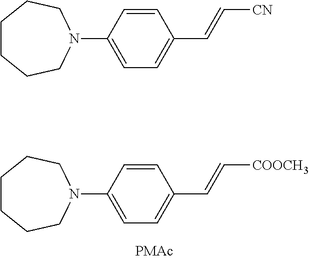 [SMILES: N#C/C=C/c1ccc(N2CCCCCC2)cc1 ; COC(=O)/C=C/c1ccc(N2CCCCCC2)cc1]

In some embodiments, the chromophore is represented by formula (VI):

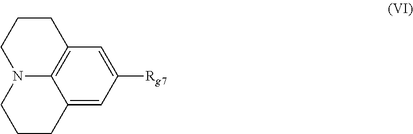

wherein R_{g7} in formula (VI) is selected from CN, CHO, or COOR, wherein R in formula (VI) is hydrogen or a C₁-C₆ alkyl. In an embodiment, the chromophore of formula (VI) is selected from one of the following compounds.

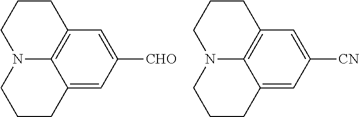 [SMILES: O=Cc1cc2c3c(c1)CCCN3CCC2 ; N#Cc1cc2c3c(c1)CCCN3CCC2]

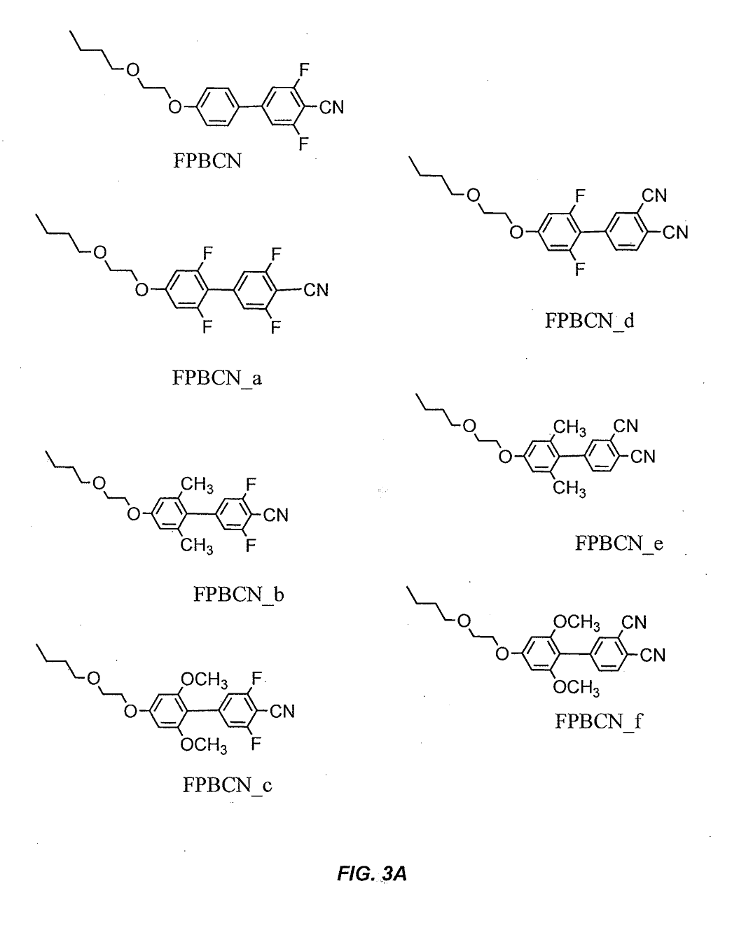

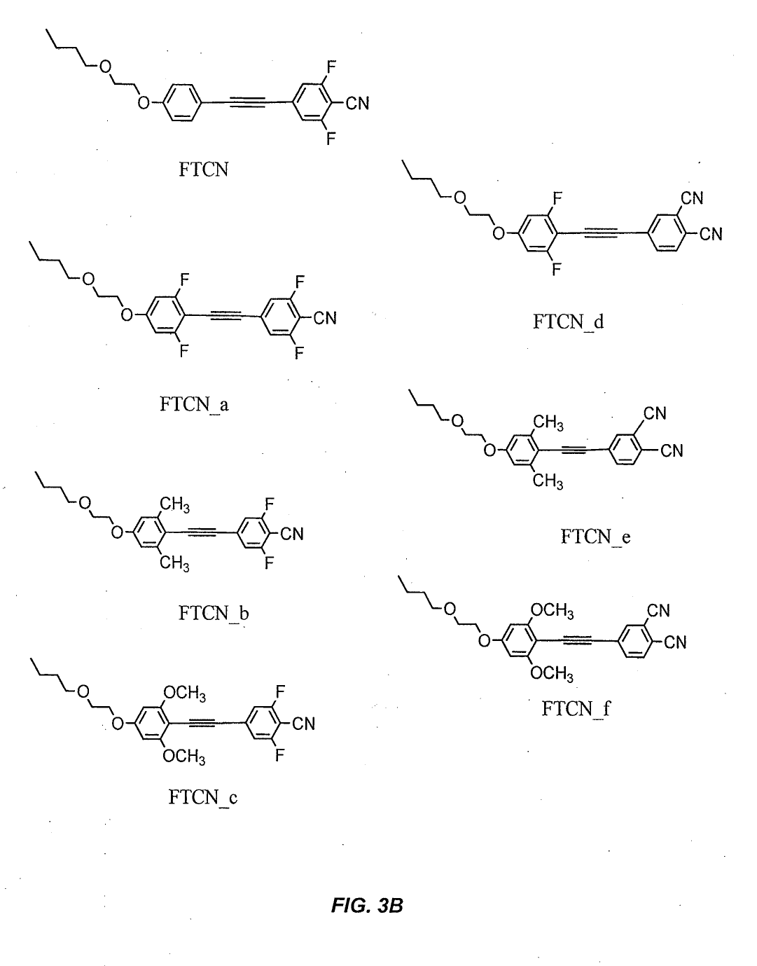

In some embodiments, the chromophore is represented by formula (VII):

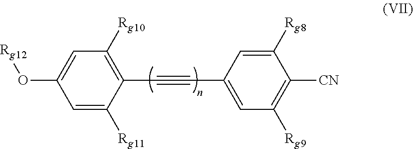

wherein n in formula (VII) is 0 or 1, R_{g8} and R_{g9} in formula (VII) are each independently selected from hydrogen, fluorine or CN, R_{g10} and R_{g11} in formula (VII) are each independently selected from hydrogen, methyl, methoxy, or fluorine, R_{g12} in formula (VII) is a C₁-C₁₀ oxyalkylene group containing 1 to 5 oxygen atoms or a C₁-C₁₀ alkyl group, and at least two of R_{g8}-R_{g12} in formula (VII) are not hydrogen. In an embodiment, at least three of R_{g8}-R_{g12} in formula (VII) are not hydrogen. In an embodiment, at least four of R_{g8}-R_{g12} in formula (VII) are not hydrogen. In an embodiment, R_{g12} in formula (VII) is —CH₂CH₂OCH₂CH₂CH₂CH₃. In an embodiment, the chromophore of formula (VII) is selected from the group of compounds shown in FIGS. 3A and 3B.

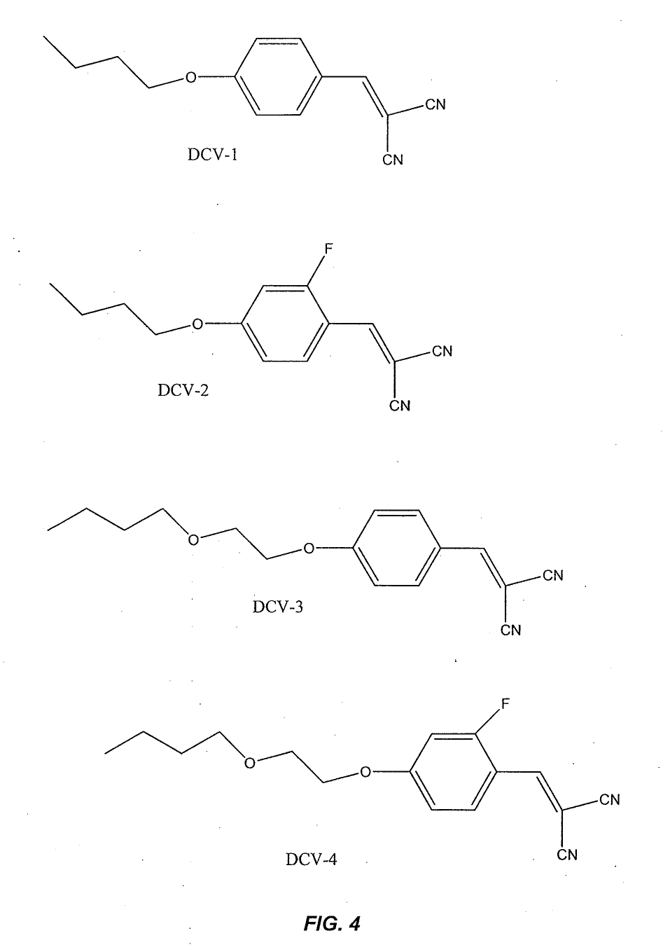

In some embodiments, the chromophore is represented by formula (VIII):

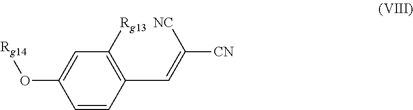

wherein R_{g13} in formula (VIII) is selected from hydrogen or fluorine, and R_{g14} in formula (VIII) is a C₁-C₆ alkyl or a C₁-C₁₀ oxyalkylene group containing 1 to 5 oxygen atoms. In an embodiment, R_{g14} is —CH₂CH₂OCH₂CH₂CH₂CH₃. In an embodiment, R_{g14} is a butyl group. In an embodiment, the chromophore of formula (VIII) is selected from the group of compounds shown in FIG. 4.

In an embodiment, the chromophore is selected from one or more of the following compounds:

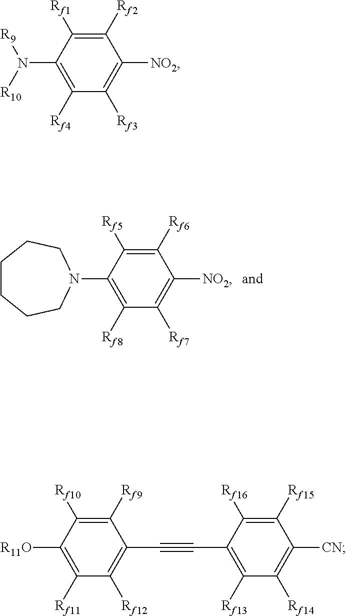

wherein each R₉-R₁₁ in the above compounds is independently selected from the group consisting of hydrogen, C₁-C₁₀ alkyl, and C₄-C₁₀ aryl, wherein the alkyl may be branched or linear, and wherein each Rf₁-Rf₁₆ is independently selected from H, F, and CF₃.

In one embodiment, material backbones, including, but not limited to, polyurethane, epoxy polymers, polystyrene, polyether, polyester, polyamide, polyimide, polysiloxane, and polyacrylate with the appropriate side chains attached, may be used to make the material matrices of the present disclosure.

Preferred types of backbone units are those based on acrylates or styrene. Particularly preferred are acrylate-based monomers, and more preferred are methacrylate monomers. The first polymeric materials to include photoconductive functionality in the polymer itself were the polyvinyl carbazole materials developed at the University of Arizona. However, these polyvinyl carbazole polymers tend to become viscous and sticky when subjected to the heat-processing methods typically used to form the polymer into films or other shapes for use in photorefractive devices.

In contrast, (meth)acrylate-based, and more specifically acrylate-based, polymers, have much better thermal and mechanical properties. That is, they provide better workability during processing by injection-molding or extrusion, for example. This is particularly true when the polymers are prepared by radical polymerization.

The photorefractive polymer composition, in an embodiment, is synthesized from a monomer incorporating at least one of the above photoconductive groups or one of the above chromophore groups. It is recognized that a number of physical and chemical properties are also desirable in the polymer matrix. It is preferred that the polymer incorporates both a charge transport group and a chromophore group, so the ability of monomer units to form copolymers is preferred. Physical properties of the formed copolymer that are of importance include, but are not limited to, the molecular weight and the glass transition temperature, T_{g}. Also, it is valuable and desirable, although optional, that the composition should be capable of being formed into films, coatings and shaped bodies of various kinds by standard polymer processing techniques, such as solvent coating, injection molding, and extrusion.

In the present invention, the polymer generally has a weight average molecular weight, M_{w}, of from about 3,000 to 500,000, preferably from about 5,000 to 100,000. The term “weight average molecular weight” as used herein means the value determined by the GPC (gel permeation chromatography) method in polystyrene standards, as is well known in the art.

In a non-limiting example, the polymer composition used in the photorefractive material comprises a repeating unit selected from the group consisting of the Structures (i)″, (ii)″, and (iii)″ which provides charge transport functionality:

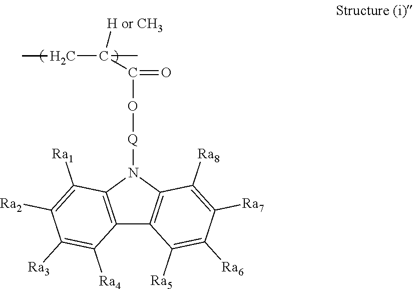

wherein Q represents an alkylene group comprising 1 to 10 carbon atoms with or without a hetero atom and Ra₁-Ra₈ are each independently selected from the group consisting of a hydrogen atom, a linear alkyl group with up to 10 carbons, a branched alkyl group with up to 10 carbons, and an aromatic group with up to 10 carbons;

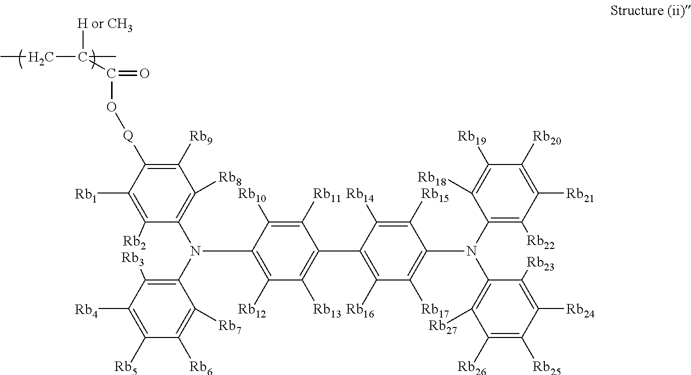

wherein Q represents an alkylene group comprising 1 to 10 carbon atoms with or without a hetero atom and Rb₁-Rb₂₇ are each independently selected from the group consisting of a hydrogen atom, a linear alkyl group with up to 10 carbons, a branched alkyl group with up to 10 carbons, and an aromatic group with up to 10 carbons;

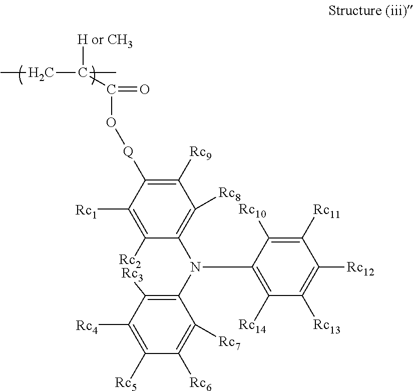

wherein Q represents an alkylene group comprising 1 to 10 carbon atoms with or without a hetero atom and Rc₁-Rc₁₄ are each independently selected from the group consisting of a hydrogen atom, a linear alkyl group with up to 10 carbons, a branched alkyl group with up to 10 carbons, and an aromatic group with up to 10 carbons.

In a non-limiting example, the polymer composition used in the photorefractive material comprises a repeating unit represented by the Structure (0)″ which provides non-linear optical functionality:

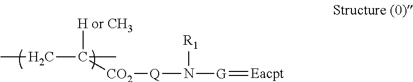

wherein Q represents an alkylene group comprising 1 to 10 carbon atoms with or without a hetero atom such as oxygen or sulfur, and preferably Q is an alkylene group represented by (CH₂)ₚ where p is between about 2 and 6. R₁ is selected from the group consisting of a hydrogen atom, a linear alkyl group with up to 10 carbons, a branched alkyl group with up to 10 carbons, and an aromatic group with up to 10 carbons, and preferably R₁ is an alkyl group selected from methyl, ethyl, propyl, butyl, pentyl and hexyl. G is a group having a bridge of π-conjugated bond. Eacpt is an electron acceptor group. Preferably Q is selected from the group consisting of ethylene, propylene, butylene, pentylene, hexylene, and heptylene. G and Eacpt are as described above with respect to Structure (0).

Further non-limiting examples of monomers including a phenyl amine derivative group as the charge transport component include carbazolylpropyl (meth)acrylate monomer; 4-(N,N-diphenylamino)-phenylpropyl (meth)acrylate; N-[(meth)acroyloxypropylphenyl]-N,N′,N′-triphenyl-(1,1′-biphenyl)-4,4′-diamine; N-[(meth)acroyloxypropylphenyl]-N′-phenyl-N,N′-di(4-methylphenyl)-(1,1′-biphenyl)-4,4′-diamine; and N-[(meth)acroyloxypropylphenyl]-N′-phenyl-N,N′-di(4-buthoxyphenyl)-(1,1′-biphenyl)-4,4′-diamine. Such monomers can be used singly or in mixtures of two or more monomers.

Further non-limiting examples of monomers including a chromophore group as the non-linear optical component include N-ethyl, N-4-dicyanomethylidenyl acrylate and N-ethyl, N-4-dicyanomethylidenyl-3,4,5,6,10-pentahydronaphtylpentyl acrylate.

Diverse polymerization techniques are known in the art to manufacture polymers from the above discussed monomers. One such conventional technique is radical polymerization, which is typically carried out by using an azo-type initiator, such as AIBN (azoisobutyl nitrile). In this radical polymerization method, the polymerization catalysis is generally used in an amount of from about 0.01 to 5 mol %, preferably from about 0.1 to 1 mol %, per mole of the sum of the polymerizable monomers.

In one embodiment of the present disclosure, conventional radical polymerization can be carried out in the presence of a solvent, such as ethyl acetate, tetrahydrofuran, butyl acetate, toluene or xylene. The solvent is generally used in an amount of from about 100 to 10000 wt %, and preferably from about 1000 to 5000 wt %, per weight of the sum of the polymerizable monomers.

In an alternative embodiment, conventional radical polymerization is carried out without a solvent in the presence of an inert gas. In one embodiment, the inactive gas comprises one of nitrogen, argon, and helium. The gas pressure during polymerization ranges from about 1 to 50 atm, and preferably from about 1 to 5 atm.

The conventional radical polymerization is preferably carried out at a temperature of from about 50° C. to 100° C. and is allowed to continue for about 1 to 100 hours, depending on the desired final molecular weight and polymerization temperature and taking into account the polymerization rate.

By carrying out the radical polymerization technique based on the teachings and preferences given above, it is possible to prepare polymers having charge transport groups, polymers having non-linear optical groups, and random or block copolymers carrying both charge transport and non-linear optical groups. Polymer systems may further be prepared from combinations of these polymers. Additionally, by following the techniques described herein, it is possible to prepare such materials with exceptionally good properties, such as photoconductivity, response time, and diffraction efficiency.

If the polymer is made from monomers that provide only charge transport ability, the photorefractive composition of the invention can be made by dispersing a component that possesses non-linear optical properties through the polymer matrix, as is described in U.S. Pat. No. 5,064,264 to IBM, which is incorporated herein by reference. Suitable materials are known in the art and are well described in the literature, such as D. S. Chemla & J. Zyss, “Nonlinear Optical Properties of Organic Molecules and Crystals” (Academic Press, 1987), incorporated herein by reference. Also, as described in U.S. Pat. No. 6,090,332 to Seth R. Marder et. al., hereby incorporated by reference, fused ring bridge, ring locked chromophores that form thermally stable photorefractive compositions can be used. For typical, non-limiting examples of chromophore additives, the following chemical structure compounds can be used:

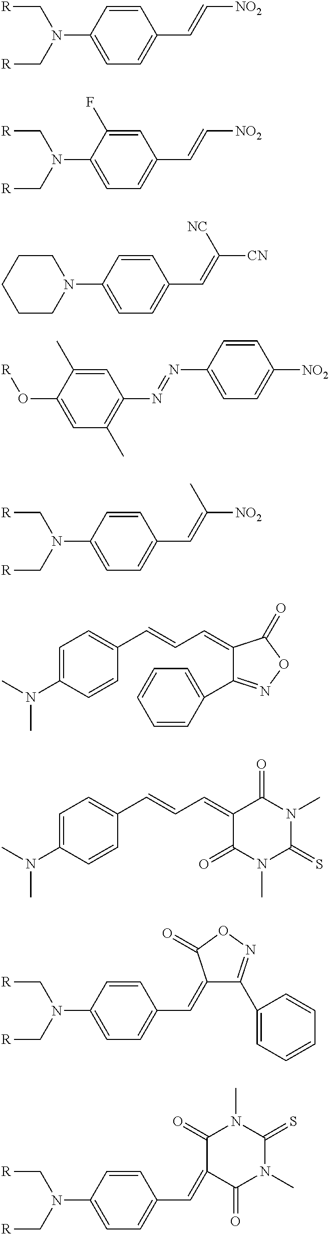

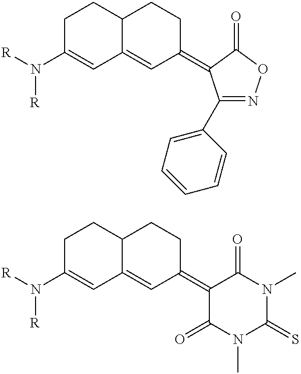

wherein each R in the chromophore additives above is independently selected from the group consisting of hydrogen, C₁-C₁₀ alkyl and C₄-C₁₀ aryl, wherein the alkyl may be branched or linear.

The chosen compound or compounds are may be mixed in the matrix copolymer in a concentration of about up to 80 wt %, more preferably up to about 40 wt %.

On the other hand, if the polymer is made from monomers that provide only the non-linear optical ability, the photorefractive composition can be made by mixing a component that possesses charge transport properties into the polymer matrix, again as is described in U.S. Pat. No. 5,064,264 to IBM. Preferred charge transport compounds are good hole transfer compounds, for example, N-alkyl carbazole or triphenylamine derivatives.

As an alternative, or in addition to, adding the charge transport component in the form of a dispersion of entities comprising individual molecules with charge transport capability, a polymer blend can be made of individual polymers with charge transport and non-linear optical abilities. For the charge transport polymer, the polymers already described above, such as those containing phenyl-amine derivative side chains, can be used. Since polymers containing only charge transport groups are comparatively easy to prepare by conventional techniques, the charge transport polymer may be made by radical polymerization or by any other convenient method.

To prepare the non-linear optical containing copolymer, monomers that have side-chain groups possessing non-linear-optical ability may be used. Non-limiting examples of monomers that may be used are those containing the following chemical structures:

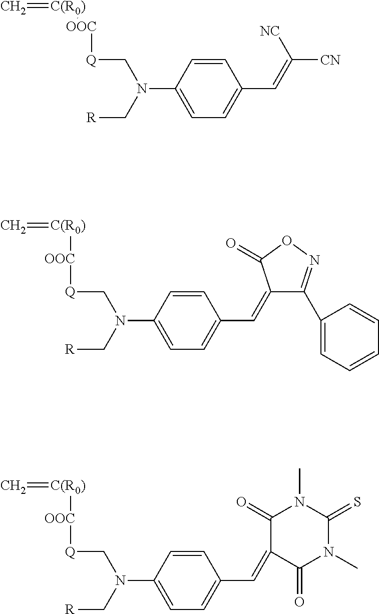

wherein Q represents an alkylene group comprising 1 to 10 carbon atoms with or without a hetero atom such as oxygen or sulfur, and preferably Q is an alkylene group represented by (CH₂)ₚ where p is between about 2 and 6; R₀ is a hydrogen atom or methyl group. R is a linear or branched alkyl group with up to 10 carbons. Preferably R is an alkyl group which is selected from methyl, ethyl, or propyl.

One technique for preparing a copolymer involves the use of a precursor monomer containing a precursor functional group for non-linear optical ability. Typically, this precursor is represented by the following general Structure (1):

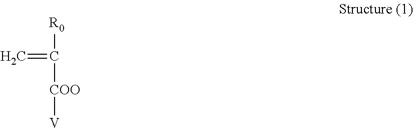

wherein R₀ is a hydrogen atom or methyl group and V is selected from the group consisting of the following structures (vi) and (vii):

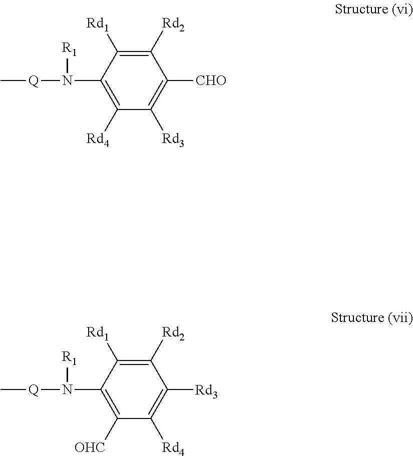

wherein, in both structures (vi) and (vii), Q represents an alkylene group comprising 1 to 10 carbon atoms with or without a hetero atom such as oxygen or sulfur, and preferably Q is an alkylene group represented by (CH₂)ₚ where p is between about 2 and 6. Rd₁-Rd₄ are independently selected from the group consisting of a hydrogen atom, a linear alkyl group with up to 10 carbons, a branched alkyl group with up to 10 carbons, and an aromatic group with up to 10 carbons, and preferably Rd₁-Rd₄ are hydrogen; and wherein R₁ represents a linear or branched alkyl group with up to 10 carbons, and preferably R₁ is an alkyl group selected from methyl, ethyl, propyl, butyl, pentyl or hexyl.

To prepare copolymers, both the non-linear optical monomer and the charge transport monomer, each of which can be selected from the types mentioned above, may be used. The procedure for performing the radical polymerization in this case involves the use of the same polymerization methods and operating conditions, with the same preferences, as described above.

After the precursor copolymer has been formed, it can be converted into the corresponding copolymer having non-linear optical groups and capabilities by a condensation reaction. Typically, the condensation reagent may be selected from the group consisting of:

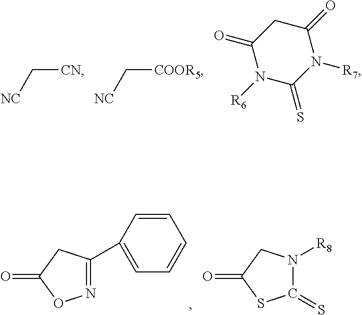

wherein R₅, R₆, R₇ and R₈ are each independently selected from the group consisting of a hydrogen atom, a linear alkyl group with up to 10 carbons, a branched alkyl group with up to 10 carbons, and an aromatic group with up to 10 carbons.

The condensation reaction can be done at room temperature for about 1-100 hrs, in the presence of a pyridine derivative catalyst. A solvent, such as butyl acetate, chloroform, dichloromethylene, toluene or xylene can be used. Optionally, the reaction may be carried out without the catalyst at a solvent reflux temperature of about 30° C. or above for about 1 to 100 hours.

It has been discovered that use of a monomer containing a precursor group for non-linear-optical ability, and conversion of that group after polymerization tends to result in a polymer product of lower polydispersity than the case if a monomer containing the non-linear-optical group is used. This is, therefore, one preferred technique for formation of the photorefractive composition.

There are no restrictions on the ratio of monomer units for the copolymers comprising a repeating unit including the first moiety having charge transport ability, a repeating unit including the second moiety having non-linear-optical ability, and, optionally, a repeating unit including the third moiety having plasticizing ability. However, as a typical representative example, the ratio per 100 weight parts of a (meth)acrylic monomer having charge transport ability relative to a (meth)acrylate monomer having non-linear optical ability ranges between about 1 and 200 weight parts and preferably ranges between about 10 and 100 weight parts. If this ratio is less than about 1 weight part, the charge transport ability of copolymer itself is weak and the response time tends to be too slow to give good photorefractivity. However, even in this case, the addition of already described low molecular weight components having non-linear-optical ability can enhance photorefractivity. On the other hand, if this ratio is more than about 200 weight parts, the non-linear-optical ability of copolymer itself is weak, and the diffraction efficiency tends to be too low to give good photorefractivity. However, even in this case, the addition of already described low molecular weight components having charge transport ability can enhance photorefractivity.

Optionally, other components may be added to the polymer matrix to provide or improve the desired physical properties mentioned earlier in this section. Usually, for good photorefractive capability, it is preferred to add a photosensitizer to serve as a charge generator. A wide choice of such photosensitizers is known in the art. One suitable sensitizer includes a fullerene. “Fullerenes” are carbon molecules in the form of a hollow sphere, ellipsoid, tube, or plane, and derivatives thereof. One example of a spherical fullerene is C₆₀. While fullerenes are typically comprised entirely of carbon molecules, fullerenes may also be fullerene derivatives that contain other atoms, e.g., one or more substituents attached to the fullerene. In an embodiment, the sensitizer is a fullerene selected from C₆₀, C₇₀, C₈₄, each of which may optionally be substituted. In an embodiment, the fullerene is selected from soluble C₆₀ derivative [6,6]-phenyl-C61-butyricacid-methylester, soluble C₇₀ derivative [6,6]-phenyl-C₇₁-butyricacid-methylester, or soluble C₈₄ derivative [6,6]-phenyl-C₈₅-butyricacid-methylester. Fullerenes can also be in the form of carbon nanotubes, either single-wall or multi-wall. The single-wall or multi-wall carbon nanotubes can be optionally substituted with one or more substituents. Another suitable sensitizer includes a nitro-substituted fluorenone. Non-limiting examples of nitro-substituted fluorenones include nitrofluorenone, 2,4-dinitrofluorenone, 2,4,7-trinitrofluorenone, and (2,4,7-trinitro-9-fluorenylidene)malonitrile. Fullerene and fluorenone are non-limiting examples of photosensitizers that may be used. The amount of photosensitizer required is usually less than about 3 wt %.

The compositions can also be mixed with one or more components that possess plasticizer properties into the polymer matrix to form the photorefractive composition. Any commercial plasticizer compound can be used, such as phthalate derivatives or low molecular weight hole transfer compounds, for example N-alkyl carbazole or triphenylamine derivatives or acetyl carbazole or triphenylamine derivatives. N-alkyl carbazole or triphenylamine derivatives containing electron acceptor group, depicted in the following structures 4, 5, or 6, can help the photorefractive composition more stable, since the plasticizer contains both N-alkyl carbazole or triphenylamine moiety and non-liner optics moiety in one compound.

Non-limiting examples of the plasticizer include ethyl carbazole; 4-(N,N-diphenylamino)-phenylpropyl acetate; 4-(N,N-diphenylamino)-phenylmethyloxy acetate; N-(acetoxypropylphenyl)-N,N′,N′-triphenyl-(1,1′-biphenyl)-4,4′-diamine; N-(acetoxypropylphenyl)-N′-phenyl-N,N′-di(4-methylphenyl)-(1,1′-biphenyl)-4,4′-diamine; and N-(acetoxypropylphenyl)-N′-phenyl-N,N′-di(4-buthoxyphenyl)-(1,1′-biphenyl)-4,4′-diamine. Such compounds can be used singly or in mixtures of two or more monomers. Also, un-polymerized monomers can be low molecular weight hole transfer compounds, for example 4-(N,N-diphenylamino)-phenylpropyl (meth)acrylate; N-[(meth)acroyloxypropylphenyl]-N,N′,N′-triphenyl-(1,1′-biphenyl)-4,4′-diamine; N-[(meth)acroyloxypropylphenyl]-N′-phenyl-N,N′-di(4-methylphenyl)-(1,1′-biphenyl)-4,4′-diamine; and N-[(meth)acroyloxypropylphenyl]-N′-phenyl-N,N′-di(4-buthoxyphenyl)-(1,1′-biphenyl)-4,4′-diamine. Such monomers can be used singly or in mixtures of two or more monomers.

Preferably, as another type of plasticizer, N-alkyl carbazole or triphenylamine derivatives, which contains electron acceptor group, as depicted in the following Structures 4, 5, or 6, can be used:

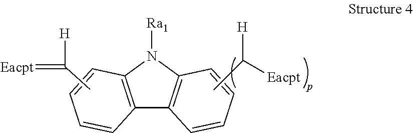

wherein Ra₁ is independently selected from the group consisting of a hydrogen atom, a linear alkyl group with up to 10 carbons, a branched alkyl group with up to 10 carbons, and an aromatic group with up to 10 carbons; p is 0 or 1;

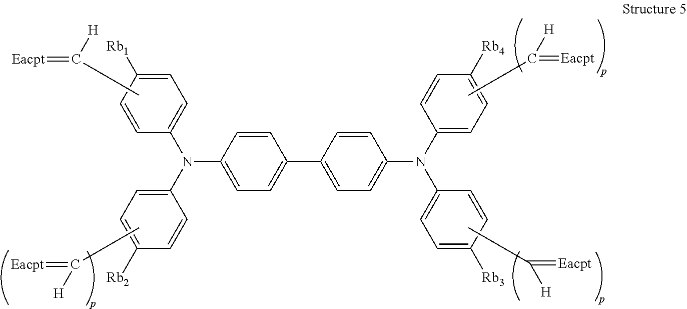

wherein Rb₁-Rb₄ are each independently selected from the group consisting of a hydrogen atom, a linear alkyl group with up to 10 carbons, a branched alkyl group with up to 10 carbons, and an aromatic group with up to 10 carbons; p is 0 or 1;

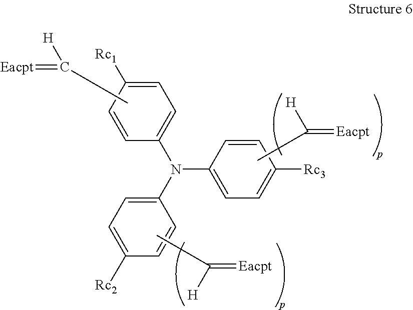

wherein Rc₁-Rc₃ are each independently selected from the group consisting of a hydrogen atom, a linear alkyl group with up to 10 carbons, a branched alkyl group with up to 10 carbons, and an aromatic group with up to 10 carbons; p is 0 or 1; wherein Eacpt is ═O or an electron acceptor group and represented by a structure selected from the group consisting of the structures:

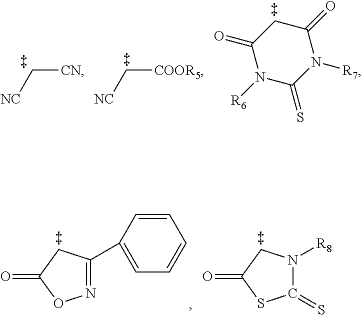

wherein R₅, R₆, R₇ and R₈ are each independently selected from the group consisting of a hydrogen atom, a linear alkyl group with up to 10 carbons, a branched alkyl group with up to 10 carbons, and an aromatic group with up to 10 carbons.

Preferred embodiments of the invention provide polymers of comparatively low T_{g} when compared with similar polymers prepared in accordance with conventional methods. The inventors have recognized that this provides a benefit in terms of lower dependence on plasticizers. By selecting copolymers of intrinsically moderate T_{g} and by using methods that tend to depress the average T_{g}, it is possible to limit the amount of plasticizer required for the composition to preferably no more than about 30% or 25%, and more preferably lower, such as no more than about 20%.

### EXAMPLES

It has been discovered that embodiments of photorefractive devices produced using the systems and methods disclosed above can achieve fast response time, good grating efficiency, fast decay time and good protection from voltage breakdown.

These benefits are further shown by the following examples, which are intended to be illustrative of the embodiments of the disclosure, but are not intended to limit the scope or underlying principles in any way.

### (a) Monomers Containing Charge Transport Groups

### TPD Acrylate Monomer

Triphenyl diamine type (N-[acroyloxypropylphenyl]-N,N′,N′-triphenyl-(1,1′-biphenyl)-4,4′-diamine) (TPD acrylate) were purchased from Wako Chemical, Japan. The TPD acrylate type monomers have the structure:

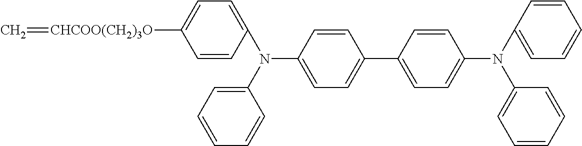

### (b) Monomers Containing Non-Linear-Optical Groups

The non-linear-optical precursor monomer 5-[N-ethyl-N-4-formylphenyl]amino-pentyl acrylate was synthesized according to the following synthesis scheme:

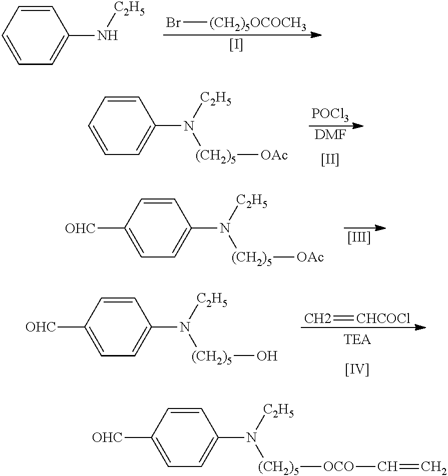

### Step I:

Into bromopentyl acetate (about 5 mL or 30 mmol) and toluene (about 25 mL), triethylamine (about 4.2 mL or 30 mmol) and N-ethylaniline (about 4 mL or 30 mmol) were added at about room temperature. This solution was heated to about 120° C. overnight. After cooling down, the reaction mixture was rotary-evaporated. The residue was purified by silica gel chromatography (developing solvent: hexane/acetone=about 9/1). An oily amine compound was obtained. (Yield: about 6.0 g (80%))

### Step II:

Anhydrous DMF (about 6 mL or 77.5 mmol) was cooled in an ice-bath. Then, POCl₃ (about 2.3 mL or 24.5 mmol) was added dropwise into a roughly 25 mL flask, and the mixture was allowed to come to room temperature. The amine compound (about 5.8 g or 23.3 mmol) was added through a rubber septum by syringe with dichloroethane. After stirring for about 30 min., this reaction mixture was heated to about 90° C. and the reaction was allowed to proceed overnight under an argon atmosphere.

After the overnight reaction, the reaction mixture was cooled, and poured into brine water and extracted by ether. The ether layer was washed with potassium carbonate solution and dried over anhydrous magnesium sulfate. After removing the magnesium sulfate, the solvent was removed and the residue was purified by silica gel chromatography (developing solvent: hexane/ethyl acetate=about 3/1). An aldehyde compound was obtained. (Yield: about 4.2 g (65%))

### Step III:

The aldehyde compound (about 3.92 g or 14.1 mmol) was dissolved with methanol (about 20 mL). Into this mixture, potassium carbonate (about 400 mg) and water (about 1 mL) were added at room temperature and the solution was stirred overnight. The next day, the solution was poured into brine water and extracted by ether. The ether layer was dried over anhydrous magnesium sulfate. After removing the magnesium sulfate, the solvent was removed and the residue was purified by silica gel chromatography (developing solvent: hexane/acetone=about 1/1). An aldehyde alcohol compound was obtained. (Yield: about 3.2 g (96%))

### Step IV:

The aldehyde alcohol (about 5.8 g or 24.7 mmol) was dissolved with anhydrous THF (about 60 mL). Into the solution, triethylamine (about 3.8 mL or 27.1 mmol) was added and the solution was cooled by ice-bath. Acrolyl chloride (about 2.1 mL or 26.5 mmol) was added and the solution was maintained at 0° C. for 20 minutes. Thereafter, the solution was allowed to warm up to room temperature and stirred at room temperature for 1 hour, at which point TLC indicated that all of the alcohol compound had disappeared. The solution was poured into brine water and extracted by ether. The ether layer was dried over anhydrous magnesium sulfate. After removing the magnesium sulfate, the solvent was removed and the residue acrylate compound was purified by silica gel chromatography (developing solvent: hexane/acetone=about 1/1). The compound yield was about 5.38 g (76%), and the compound purity was about 99% (by GC).

### c) Synthesis of Non-Linear-Optical Chromophore 7-FDCST

The non-linear-optical precursor 7-FDCST (7 member ring dicyanostyrene, 4-homopiperidino-2-fluorobenzylidene malononitrile) was synthesized according to the following two-step synthesis scheme:

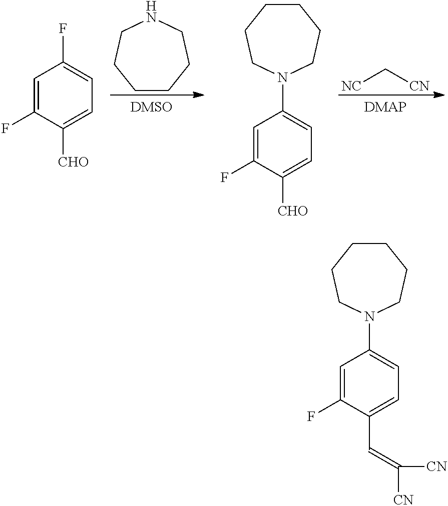

A mixture of 2,4-difluorobenzaldehyde (about 25 g or 176 mmol), homopiperidine (about 17.4 g or 176 mmol), lithium carbonate (about 65 g or 880 mmol), and DMSO (about 625 mL) was stirred at about 50° C. for about 16 hours. Water (about 50 mL) was added to the reaction mixture. The products were extracted with ether (about 100 mL). After removal of ether, the crude products were purified by silica gel column chromatography using hexanes-ethyl acetate (about 9:1) as eluent and crude intermediate was obtained (about 22.6 g,). 4-(dimethylamino)pyridine (about 230 mg) was added to a solution of the 4-homopiperidino-2-fluorobenzaldehyde (about 22.6 g or 102 mmol) and malononitrile (about 10.1 g or 153 mmol) in methanol (about 323 mL). The reaction mixture was kept at room temperature and the product was collected by filtration and purified by recrystallization from ethanol. The compound yield was about 18.1 g (38%)

### d) Synthesis of Non-Linear Optical Chromophore 1-hexamethyleneimine-4-nitrobenzene

The non-linear-optical, chromophore 1-hexamethyleneimine-4-nitrobenzene was synthesized according to the following synthesis scheme:

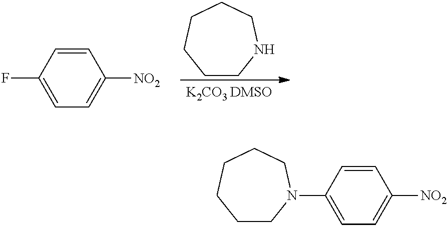 [SMILES: O=[N+]([O-])c1ccc(F)cc1 ; C1CCCNCC1 ; O=[N+]([O-])c1ccc(N2CCCCCC2)cc1]

A mixture of 4-fluorobenzaldehyde (3 g, 21.26 mmol), homopiperidine (2.11 g, 21.26 mmol), lithium carbonate (3.53 g, 25.512 mmol), and DMSO (40 mL) was stirred at 50° C. for 16 hours. Water (50 mL) was added to the reaction mixture. The products were extracted with ether (100 mL). After removal of ether, the crude products were recrystallized and yellow crystal was obtained. The compound yield was 4.45 g (95%).

### (e) Synthesis of Non-Linear Optical Chromophore methyl 3-(4-(azepan-1-yl)phenyl)acrylate

The non-linear-optical chromophore methyl 3-(4-(azepan-1-yl)phenyl)acrylate was synthesized according to the following synthesis scheme:

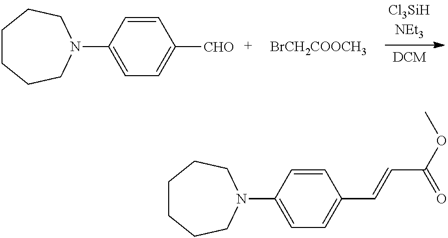

In a 250 mL two-neck flask, anhydrous methylene chloride (60 mL) and 4-(azepan-1-yl)benzaldehyde (4.06 g, 20 mmol) were added. Then, methyl 2-bromoacetate (7.04 g, 46 mmol) followed by triethylamine (10.1 g, 100 mmol) and trichlorosilane (5.41 g, 40 mmol) were added at −10° C. under nitrogen atmosphere. The mixture was stirred at −10° C. for 8 hours and then gradually warmed to room temperature overnight. The reaction mixture was quenched by saturated NaHCO₃ aqueous solution and water. The products were extracted with ether and washed by brine and dried over MgSO₄. The crude products were purified by column. The compound yield was 2.48 g (48%).

### (f) Sensitizer

Sensitizer C₆₀ derivative [6,6]-phenyl-C₆₁-butyric acid methyl ester (PCBM, 99%, American Dye Source Inc.) is commercially available and was used as received.

### (g) Plasticizer

N-ethylcarbazole is commercially available from Aldrich Chemical Co. and was used after recrystallization.

### (h) Matrix Polymer

### Production Example 1

### Preparation of TPD Acrylate/Chromophore Type 10:1 Copolymer by AIBN Radical Initiated Polymerization

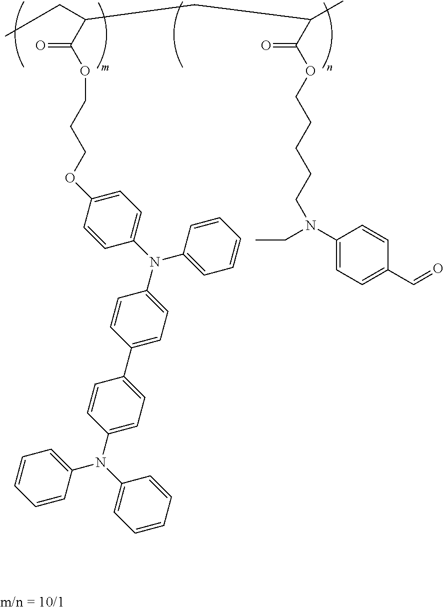

The charge transport monomer N-[(meth)acroyloxypropylphenyl]-N,N′,N′-triphenyl-(1,1′-biphenyl)-4,4′-diamine (TPD acrylate) (about 43.34 g), and the non-linear-optical precursor monomer 5-[N-ethyl-N-4-formylphenyl]amino-pentyl acrylate (about 4.35 g), prepared as described in step (b) above, were put into a three-necked flask. After toluene (about 400 mL) was added and purged by argon gas for about 1 hour, azoisobutylnitrile (about 118 mg) was added into this solution. Then, the solution was heated to about 65° C., while continuing to purge with argon gas.

After about 18 hours of polymerization, the polymer solution was diluted with toluene. The polymer was precipitated from the solution and added to methanol, and the resulting polymer precipitate was collected and washed in diethyl ether and methanol. The white polymer powder was collected and dried. The yield of polymer was about 66%.

The weight average and number average molecular weights were measured by gel permeation chromatography, using polystyrene standard. The results were M₁=about 10,600, M_{w}=about 17,100, giving a polydispersity of about 1.61.

### i) Fabrication of Polymer Layer Modified ITO Glass

About 2 g of polymer (APC, PMMA, Sol-gel or polyimide) powder was dissolved in about 20 ml cyclopentanone. The solution was stirred under ambient condition overnight to ensure substantially total dissolution. The solution was then filtered through an approximately 0.2 μm PTFE filter and spin-coated onto ITO glass substrate. The film was then pre-baked at about 80° C. for about 60s and followed by vacuum baking at about 80° C. overnight. The resulted polymer layer thickness range was from 0.5-50 μm, depending on the initial spin-coating speed and polymer concentration, along with coating method.

### j) Fabrication of Electrolytes Dispersed Polymer Layer Modified ITO Glass

Fabrication of electrolytes dispersed polymer layer modified ITO glass was obtained in the same manner as in fabrication of polymer layer modified ITO glass except that the polymer layers were dispersed with different kinds of electrolytes having different amounts of electrolyte based upon the weight of the polymer before the spin coating.

### Example 1

### Preparation of Photorefractive Devices

A photorefractive composition testing sample was prepared comprising two ITO-coated glass electrodes, two polymer layers, and a photorefractive layer. The components of the photorefractive composition in the photorefractive layer were approximately as follows:

| | |
|---|---|
| (i) Matrix polymer (described in Production Example 1): | 49.80 wt % |
| (ii) Chromophore 1-hexamethyleneimine-4-nitrobenzene | 29.88 wt % |
| (iii) Ethyl carbazole plasticizer | 19.92 wt % |
| (iv) PCMB sensitizer | 0.4 wt % |

To prepare the photorefractive composition, the components listed above were dissolved with toluene and stirred overnight at room temperature. After removing the solvent by rotary evaporator and vacuum pump, the residue was scratched and gathered.

This powdery residue mixture, which is used to form the photorefractive layer, was put on a slide glass and melted at about 125° C. to make an approximately 200-300 μm thickness film, or pre-cake. A first electrode layer and a second electrode layer are positioned on opposite sides of the photorefractive material, with a first polymer layer interposed between the first electrode layer and the photorefractive material, and a second polymer layer interposed between the second electrode layer and the photorefractive material. Each polymer layer used in Example 1 is APC (amorphous polycarbonate) polymer, which was dissolved with dichloromethane into an approximately 30% solution. The polymer solution was then dispersed with 0.1 wt % of tetrabutylammonium hexafluorophosphate electrolyte. This polymer solution was coated on the top of ITO covered glass-plate (e.g. electrode layer) with spin-coating machine and dried in an oven (80° C. for 10 min) to provide an approximately 20 μm thick APC layer onto each electrode layer. The APC polymer (containing 0.1 wt % electrolyte) overlaid the indium tin oxide on each layer.

Then, small portions of the pre-cake photorefractive layer were taken off the slide glass and sandwiched between two APC coated indium tin oxide (ITO) glass plates separated by an approximately 65 μm spacer to form the individual samples. Thus, the photorefractive material had two layers of polymer (APC) on opposite sides thereof with the two electrode layers on the opposite sides of each the polymer layers. Each of the polycarbonate layers had a thickness of approximately 20 microns, for a total polymer thickness of approximately 40 microns in the photorefractive device. The photorefractive composition layer had a thickness of approximately 65 μm.

### Measurement Method 1: Diffraction Efficiency

The diffraction efficiency was measured as a function of the applied field, by four-wave mixing experiments at about 532 nm with two s-polarized writing beams and a p-polarized probe beam. The angle between the bisector of the two writing beams and the sample normal was about 60 degrees and the angle between the writing beams was adjusted to provide an approximately 2.5 μm grating spacing in the material (about 20 degrees). The writing beams had approximately equal optical powers of about 0.45 mW/cm², leading to a total optical power of about 1.5 mW on the polymer, after correction for reflection losses. The beams were collimated to a spot size of approximately 500 μm. The optical power of the probe was about 100 μW.

The measurement of diffraction efficiency peak bias was done as follows: The electric field (V/μm) applied to the photorefractive sample was varied from about 0 V/μm all the way up to about 100 V/μm with certain time period (typically about 400 s), and the sample was illuminated with the two writing beams and the probe beam during this time period. Then, the diffracted beam was recorded. According to the theory,

$$η \sim {sin}^{2} ( k \frac{{E}_{o} {E}_{o}^{G}}{\sqrt{1 + {( {E}_{o}^{G} / {E}_{q} )}^{2}}} )$$

wherein E₀^{G} is the component of E₀ along the direction of the grating wave-vector and E_{q} is the trap limited saturation space-charge field. The diffraction efficiency will show maximum peak value at certain applied bias. The peak diffraction efficiency bias thus is a very useful parameter to determine the device performance.

### Measurement Method 2: Relative Dielectric Constant

The relative dielectric constant of a material under given conditions is a measure of the extent to which it concentrates electrostatic lines of flux. It is the ratio of the amount of stored electrical energy when a potential is applied, relative to the permittivity of a vacuum. It is also called relative permittivity.

The dielectric constant is represented as ∈ᵣ or sometimes κ or K. It is defined as:

$${ɛ}_{r} = \frac{{ɛ}_{s}}{{ɛ}_{0}}$$

wherein ∈ₛ is the static permittivity of the material and ∈₀ is vacuum permittivity. Vacuum permittivity is derived from Maxwell's equations by relating the electric field intensity E to the electric flux density D. In vacuum (free space), the permittivity ∈ is given by ∈₀, so the dielectric constant is 1.

The relative dielectric constant ∈ᵣ can be measured for static electric fields as follows: first the of a test capacitor C₀ is measured with vacuum between its plates. Then, using the same capacitor and distance between its plates the capacitance Cₓ with a dielectric between the plates is measured. The relative dielectric constant can be then calculated as:

$${ɛ}_{r} = \frac{{C}_{x}}{{C}_{0}}$$

For time-varying electromagnetic fields, the dielectric constant of materials becomes frequency dependent and in general is called permittivity.

### Measurement Method 3: Rising Time (Response Time)

The diffraction efficiency was measured as a function of the applied field, using a procedure similar to that described in the measurement of diffraction efficiency, by four-wave mixing experiments at 488 nm, or 532 nm, and 633 nm with s-polarized writing beams and a p-polarized probe beam. The angle between the bisector of the two writing beams and the sample normal was 60 degrees and the angle between the writing beams was adjusted to provide a 2.5 μm grating spacing in the material (˜20 degree). The writing beams had equal optical powers of 0.45 mW/cm², leading to a total optical power of 1.5 mW on the polymer, after correction for reflection losses. The beams were collimated to a spot size of approximately 500 μm. The optical power of the probe was 100 μW. The measurement of the grating buildup time was performed as follows: an electric field (V/μm) was applied to the sample, and the sample was illuminated with two writing beams and the probe beam. Then, the evolution of the diffracted beam was recorded. The response time (rising time) was estimated as the time required to reach e⁻¹ of steady-state diffraction efficiency.

### Measurement Method 4: Decay Time (Holding Time)

Grating decay was determined by first writing a photorefractive grating in to the photorefractive device until the signal reaches a steady-state. Afterwards, the two writing beams were blocked, the remaining grating was monitored under the following method: applied bias voltage on and reading beam on continuously. Some applications, including holographic data storage, such as updatable 3D holographic display, require certain grating response time and decay time for better performance. The photorefractive devices including one or more polymer layers dispersed with electrolytes described herein provide faster response time and decay time than the photorefractive devices including one or more polymer without dispersed electrolytes. Also the protection from breakdown still kept well.

The grating response and decay times were measured with varying voltages applied to the device. In example, the device was measured at 6 kV. Normally, the higher the voltage at which the device is measured, the faster the response time.

### Example 2

A photorefractive device was obtained in the same manner as in Example 1 except that the data was carried at 8 kv.

### Example 3

A photorefractive device was obtained in the same manner as in Example 1 except that the amount of tetrabutylammonium hexafluorophosphate electrolyte dispersed in each of the polymer layers was 1 wt %. The data was carried at 6 kv.

### Example 4

A photorefractive device was obtained in the same manner as in Example 1 except that the polymer layers were dispersed with 0.1 wt % of tetraphenylphosphonium bromide electrolyte instead of the tetrabutylammonium hexafluorophosphate electrolyte. The data was carried at 7 kv.

### Example 5

A photorefractive device was obtained in the same manner as in Example 1 except that the polymer layers were dispersed with 0.1 wt % of tetrabutylammonium perchlorate electrolyte instead of the tetrabutylammonium hexafluorophosphate electrolyte. The data was carried at 7 kv.

### Example 6

A photorefractive device was obtained in the same manner as in Example 1 except that the polymer layers were dispersed with 1 wt % of 10-methyl-9-phenyl acridinium perchlorate electrolyte instead of the tetrabutylammonium hexafluorophosphate electrolyte. The data was carried at 7 kv.

### Comparative Example 1

A photorefractive device was obtained in the same manner as in the Example 1 except that it was fabricated without either polymer layer, such that the photorefractive composition was adjacent two electrodes comprising bare ITO glass. Since no polymer layers were present, no electrolytes were present either. The data was carried at 5 kv.

### Comparative Example 2

A photorefractive device was obtained in the same manner as in the Example 1 with two polymer layers, except that neither of the polymer layers were dispersed with electrolytes. The data was carried at 6 kv.

The performance of each device is summarized as follows in Table 1.

TABLE 1
Grating response time, decay time, bias peak and diffraction efficiency of
photorefractive devices with 40 μm APC

| | Individual | Combined | | | | |
|---|---|---|---|---|---|---|
| | polymer | polymer | Grating | Grating | | |
| | layer | layer | response | decay | | Diffraction |
| Example | thickness | thickness | time | time | Bias peak | efficiency |
| Comp. | no | no | 0.1 s at 5 kv | 0.36 s at 5 kv | 6 kv | 57% at 5 kv |
| Ex. 1 | | | | | | |
| Comp. | 20 μm | 40 μm | 60 s at 6 kv | >530 s at 6 kv | >8 kv | 34% at 8 kv |
| Ex. 2 | | | | | | |
| Example 1 | 20 μm | 40 μm | 50 s at 6 kv | 40 s at 6 kv | >8 kv | 33% at 8 kv |
| Example 2 | 20 μm | 40 μm | 30 s at 8 kv | 45 s at 8 kv | >8 kv | 33% at 8 kv |
| Example 3 | 20 μm | 40 μm | 12 s at 6 kv | 6 s at 6 kv | >8 kv | 6% at 8 kv |
| Example 4 | 20 μm | 40 μm | 40 s at 7 kv | 95 s at 7 kv | >8 kv | 21% at 8 kv |
| Example 5 | 20 μm | 40 μm | 17 s at 7 kv | 25 s at 7 kv | >8 kv | 15% at 8 kv |
| Example 6 | 20 μm | 40 μm | 8 s at 7 kv | 10 s at 7 kv | >8 kv | 16% at 8 kv |

As illustrated by the results summarized in Table 1, both grating decay time and grating response time are greatly reduced by dispersing electrolytes into one or more polymer layers in the photorefractive device. In Example 1, the grating decay time is 40 seconds and the grating response time is 50 seconds. While in Comparative Example 2, the grating decay time is longer than 500 seconds, and grating response time is 60 seconds. As shown in Table 1, by dispersing different kind of the electrolytes and different concentration of the electrolytes, the grating decay time can be adjusted, which can be fitted for all kinds of applications with different requirements.

### Examples 7-10

A photorefractive device was obtained in the same manner as in Example 1 except that the polymer layers were dispersed with 1 wt % of tetrabutylammonium benzoate electrolyte instead of the tetrabutylammonium hexafluorophosphate electrolyte. The thickness of the two polymer layers was also reduced to about 10 μm each, for a combined polymer thickness of about 20 μm. The data was carried at 5 kv (Ex. 7), 6 kv (Ex. 8), 7 kv (Ex. 9), and 8 kv (Ex. 10), respectively.

### Example 11

A photorefractive device was obtained in the same manner as in Example 1 except that only a single polymer layer, having a thickness of about 20 μm, was used. The data was carried at 6 kv.

### Comparative Example 3

A photorefractive device was obtained in the same manner as in the Example 11 in that only a single polymer layer having a thickness of about 20 μm was used. However, no electrolytes were dispersed in the polymer layer. The data was carried at 7 kv. The performance of each device is summarized as follows in Table 2.

TABLE 2
Grating response time, decay time, bias peak and diffraction efficiency of
photorefractive devices

| | | Combined | | | | |
|---|---|---|---|---|---|---|
| | Individual | thickness | | | | |
| | polymer | of | Grating | Grating | | |
| | layer | polymer | response | decay | | Diffraction |
| Example | thickness | layers | time | time | Bias peak | efficiency |
| Comp. | no | no | 0.1 s at 5 kv | 0.36 s at 5 kv | 6 kv | 57% at 5 kv |
| Ex. 1 | | | | | | |
| Comp. | 20/0 μm | 20 μm | 5 s at 7 kv | 270 s at 7 kv | 6.5 kv | 55% at 7 kv |
| Ex. 3 | | | | | | |
| Example 7 | 10 μm | 20 μm | 4.3 s at 5 kv | 12 s at 5 kv | 5.9 kv | 28% at 5.9 kv |
| Example 8 | 10 μm | 20 μm | 2.4 s at 6 kv | 8 s at 6 kv | 5.9 kv | 28% at 5.9 kv |
| Example 9 | 10 μm | 20 μm | 1 s at 7 kv | 11 s at 7 kv | 5.9 kv | 28% at 5.9 kv |
| Example | 10 μm | 20 μm | 0.2 s at 8 kv | 15 s at 8 kv | 5.9 kv | 28% at 5.9 kv |
| 10 | | | | | | |
| Example | 20/0 μm | 20 μm | 10 s at 6 kv | 70 s at 6 kv | 6.8 kv | 54% at 6.8 kv |
| 11 | | | | | | |

As shown by the data summarized in Table 2, grating decay time is greatly decreased by dispersing electrolytes into one or more polymer layers in the photorefractive device. In Example 8, grating decay time can be as short as 8 seconds, and grating response time can be as short as 2.4 seconds. Improved properties are also seen (Example 11) even if only a single polymer layer comprising electrolytes is used.

### Example 12a, 12b, and 12c

A photorefractive device was obtained in the same manner as in Example 1 except that only a single polymer layer having a thickness of about 20 μm was used, and the polymer layer was dispersed with 1 wt % of tetrabutylammonium benzoate electrolyte instead of the tetrabutylammonium hexafluorophosphate electrolyte. The chromophore in the photorefractive material was changed to methyl 3-(4-(azepan-1-yl)phenyl)acrylate. The data was carried at 8 kv, 7 kv, and 6 kv for Example 12a, 12b and 12c, respectively.

### Example 13a, 13b, and 13c

A photorefractive device was obtained in the same manner as in Example 12, except two polymer layers, each having a thickness of about 20 μm were used instead of a single polymer layer. Both polymer layers were dispersed with 1 wt % of tetrabutylammonium benzoate electrolyte. The data was carried at 8 kv, 7 kv, and 6 kv for Example 13a, 13b and 13c, respectively. The total thickness of the polymer layers was about 40 μm.

### Example 14a, 14b, and 14c

A photorefractive device was obtained in the same manner as in Example 12 except that the polymer layer was dispersed with of tetrabutylammonium benzoate electrolyte in an amount of 0.5 wt %. The data was carried at 8 kv, 7 kv, and 6 kv for Example 14a, 14b and 14c, respectively. The total thickness of the polymer layers was about 20 μm.

### Example 15a, 15b, and 15c

A photorefractive device was obtained in the same manner as in Example 13 except that the polymer layers were dispersed with tetrabutylammonium benzoate electrolyte in an amount of 0.5 wt %. The data was carried at 8 kv, 7 kv, and 6 kv for Example 15a, 15b and 15c, respectively. The total thickness of the polymer layers was about 40 μm.

### Comparative Example 4

A photorefractive device was obtained in the same manner as in the Example 12 except that no polymer layer or electrolytes were used, such that the photorefractive composition was adjacent two electrodes comprising bare ITO glass. The data was carried at 7 kv.

### Comparative Example 5a, 5b, and 5c

A photorefractive device was obtained in the same manner as in the Example 12 except that the polymer layers were dispersed without any electrolytes. The thickness of the polymer layer was about 20 μm. The data was carried at 6 kv, 7 kv, and 8 kv for Comparative Example 5a, 5b, and 5c, respectively.

### Comparative Example 6a, 6b, and 6c

A photorefractive device was obtained in the same manner as in the Example 13 except that no electrolytes were dispersed in either polymer layer. The combined thickness of the polymer layers was about 40 μm. The data was carried at 6 kv, 7 kv, and 8 kv for Comparative Example 6a, 6b, and 6c, respectively.

TABLE 3
Grating response time and decay time of photorefractive device

| | | Combined | | | | |
|---|---|---|---|---|---|---|
| | Individual | thickness | | | | |
| | polymer | of | Grating | Grating | | |
| | layer | polymer | response | decay | | Diffraction |
| Example | thickness | layers | time | time | Bias peak | efficiency |
| Comp. | No | No | 0.05 s at | 0.4 s at | >7 kv | 34% at |
| Ex. 4 | | | 7 kv | 7 kv | | 7 kv |
| Comp. | 20/0 μm | 20 μm | 2.6 s 6 kv | 3.7 s at | >8 kv | 18% at |
| Ex. 5a | | | | 6 kv | | 6 kv |
| Comp. | 20/0 μm | 20 μm | 2 s at 7 kv | 2.4 s at | >8 kv | 24% at |
| Ex. 5b | | | | 7 kv | | 7 kv |
| Comp. | 20/0 μm | 20 μm | 1.6 s at | 1.4 s at | >8 kv | 33% at |
| Ex. 5c | | | 8 kv | 8 kv | | 8 kv |
| Comp. | 20/20 μm | 40 μm | 6.5 s at | 12.8 s at | >8 kv | 6% at 6 kv |
| Ex. 6a | | | 6 kv | 6 kv | | |
| Comp. | 20/20 μm | 40 μm | 5.6 s at | 9.2 s at | >8 kv | 10% at |
| Ex. 6b | | | 7 kv | 7 kv | | 7 kv |
| Comp. | 20/20 μm | 40 μm | 4.5 s at | 7 s at 8 kv | >8 kv | 16% at |
| Ex. 6c | | | 8 kv | | | 8 kv |
| Example | 20/0 μm | 20 μm | 1.1 s at | 2.8 s at | >8 kv | 93% at |
| 12a | | | 8 kv | 8 kv | | 8 kv |
| Example | 20/0 μm | 20 μm | 2.4 s at | 2.5 s at | >8 kv | 70% at |
| 12b | | | 7 kv | 7 kv | | 7 kv |
| Example | 20/0 μm | 20 μm | 5.1 s at | 2.5 s at | >8 kv | 44% at |
| 12c | | | 6 kv | 6 kv | | 6 kv |
| Example | 20/20 μm | 40 μm | 1.6 s at | 5.5 s at | >8 kv | 79% at |
| 13a | | | 8 kv | 8 kv | | 8 kv |
| Example | 20/20 μm | 40 μm | 3 s at 7 kv | 6.5 s at | >8 kv | 41% at |
| 13b | | | | 7 kv | | 7 kv |
| Example | 20/20 μm | 40 μm | 4.5 s at | 8 s at 6 kv | >8 kv | 25% at |
| 13c | | | 6 kv | | | 6 kv |
| Example | 20/0 μm | 20 μm | 1.7 s at | 2.2 s at | >8 kv | 47% at |
| 14a | | | 8 kv | 8 kv | | 8 kv |
| Example | 20/0 μm | 20 μm | 3.8 s at | 2.6 s at | >8 kv | 31% at |
| 14b | | | 7 kv | 7 kv | | 7 kv |
| Example | 20/0 μm | 20 μm | 3.8 s at | 4.5 at 6 kv | >8 kv | 21% at |
| 14c | | | 6 kv | | | 6 kv |
| Example | 20/20 μm | 40 μm | 5 s at 8 kv | 7.5 s at | >8 kv | 10% at |
| 15a | | | | 8 kv | | 8 kv |
| Example | 20/20 μm | 40 μm | 7 s at 7 kv | 9 s at 7 kv | >8 kv | 5% at 7 kv |
| 15b | | | | | | |
| Example | 20/20 μm | 40 μm | 5 s at 6 kv | 15 s at | >8 kv | 3% at 6 kv |
| 15c | | | | 6 kv | | |

As illustrated by the comparative examples data in Table 3, the grating diffraction efficiency is greatly increased by dispersing electrolytes into one or more polymer layers in the photorefractive device compared to the devices without any electrolytes dispersed into the polymer layer when measured by a laser beam. In Example 12a, the grating diffraction efficiency was 93% compared to 33% for Comparative Example 5c. In Example 13a, the grating diffraction efficiency was 79% compared to 16% for Comparative Example 6c. In Example 14a, the grating diffraction efficiency was 47% compared to 33% for Comparative Example 5c.

### Comparative Example 7

A photorefractive device was obtained in the same manner as in Comparative Example 1 except that the chromophore used in the photorefractive composition was changed to 7-FDCST.

### Example 16

A photorefractive device was obtained in the same manner as in Example 1 except that the chromophore used in the photorefractive composition was changed to 7-FDCST. Also, each of the polymer layer thickness was approximately 10 μm, giving a combined thickness of the polymer layers of approximately 20 μm. No electrolyte was dispersed in either polymer layer.

### Example 17

A photorefractive device was obtained in the same manner as in Example 1 except that the chromophore used in the photorefractive composition was changed to 7-FDCST. No electrolyte was dispersed in either polymer layer.

### Example 18

A photorefractive device was obtained in the same manner as in Example 1 except that the chromophore used in the photorefractive composition was changed to 7-FDCST. Also, each of the polymer layer thickness was approximately 10 μm, giving a combined thickness of the polymer layers of approximately 20 μm. The electrolyte in each of the polymer layers was changed to 1 wt % of 10-methyl-9-phenylacridinium perchlorate.

### Example 19

A photorefractive device was obtained in the same manner as in Example 1 except that the chromophore used in the photorefractive composition was changed to 7-FDCST. Also, the electrolyte in the polymer layers was changed to 1 wt % of 10-methyl-9-phenylacridinium perchlorate. The performance of each device is summarized as follows in Table 4.

TABLE 4
peak diffraction efficiency of photorefractive device

| | | | | | Relative | |
|---|---|---|---|---|---|---|
| | | | | | dielectric | |
| | | | | Polymer layer | constant | Peak |
| | | | | between ITO | of | Diffraction |
| | | | Ethyl | and | polymer | Efficiency |
| | Matrix | 7-FDCST | carbazole | photorefractive | in buffer | bias |
| Example | Polymer | chromophore | plasticizer | composition | layer | (V/μm) |
| 16 | 50 | 30 | 20 | 20 μm APC | 3.2 | 26 |
| 17 | 50 | 30 | 20 | 40 μm APC | 3.2 | 25 |
| 18 | 50 | 30 | 20 | 20 μm APC | n/a | 30 |
| | | | | with | | |
| | | | | electrolyte | | |
| 19 | 50 | 30 | 20 | 40 μm APC | n/a | 25 |
| | | | | with | | |
| | | | | electrolyte | | |
| Comp. | 50 | 30 | 20 | n/a | n/a | 55 |
| Ex. 7 | | | | | | |

As illustrated by the comparative example data, the peak diffraction efficiency bias can be reduced from about 55 V/μm in the non-polymer layer incorporated devices to about 25 V/μm to 30 V/μm for a 532 nm laser beam by interposing polymer layers, either with or without dispersed electrolytes. Importantly, the electrolytes did not show any negative effect on the bias voltage reduction previously demonstrated by incorporating polymer layers alone without electrolytes.

### Comparative Example 8

A photorefractive device was obtained in the same manner as in Comparative Example 7, except the data was carried at 5.5 kv.

### Comparative Example 9

A photorefractive device was obtained in the same manner as in Example 1 except that the chromophore used in the photorefractive composition was changed to 7-FDCST. Each of the polymer layer thicknesses was approximately 20 μm, thus giving a combined thickness of the polymer layers of approximately 40 μm. No electrolytes were dispersed in the polymer layers. The data was carried at 3.5 kv.

### Example 20

A photorefractive device was obtained in the same manner as in Comparative Example 9 except that the electrolyte in each of the polymer layers was changed to 1 wt % of 10-methyl-9-phenylacridinium perchlorate.

### Example 21

A photorefractive device was obtained in the same manner as in Example 20 except that the polymer layers were each about 10 μm thick for a total polymer thickness of about 20 μm.

### Example 22

A photorefractive device was obtained in the same manner as in Comparative Example 9 except that the electrolyte in each of the polymer layers was changed to 0.5 wt % of 10-methyl-9-phenylacridinium perchlorate.

### Example 23

A photorefractive device was obtained in the same manner as in Comparative Example 9 except that the electrolyte in each of the polymer layers was changed to 2 wt % of 10-methyl-9-phenylacridinium perchlorate. The data was carried at 4.8 kv. The performance of each device is summarized as follows in Table 5.

TABLE 5
Grating response time and decay time of photorefractive device

| | | Combined | | | | |
|---|---|---|---|---|---|---|
| | Individual | thickness | | | | |
| | polymer | of | Grating | Grating | | |
| | layer | polymer | response | decay | | Diffraction |
| Example | thickness | layers | time | time | Bias peak | efficiency |
| Comp. | no | no | 0.16 s at 5.5 kv | 0.1 s at 5.5 kv | 5.5 kv | 70% at 5.5 kv |
| Ex. 8 | | | | | | |
| Comp. | 20 μm | 40 μm | 10 s at 3.5 kv | >300 s at 3.5 kv | 3.5 kv | 70% at 3.5 kv |
| Ex. 9 | | | | | | |
| Example | 20 μm | 40 μm | 13 at 3.5 kv | 32 s at 3.5 kv | 3.5 kv | 45% at 3.5 kv |
| 20 | | | | | | |
| Example | 10 μm | 20 μm | 8 at 3.5 kv | 11 s at 3.5 kv | 3.6 kv | 52% at 3.5 kv |
| 21 | | | | | | |
| Example | 20 μm | 40 μm | 16 at 3.5 kv | 48 s at 3.5 kv | 4.2 kv | 60% at 3.5 kv |
| 22 | | | | | | |
| Example | 20 μm | 40 μm | 8 at 4.8 kv | 32 s at 4.8 kv | 4.8 kv | 52% at 3.5 kv |
| 23 | | | | | | |

As illustrated in Table 5, the grating decay time is greatly reduced by dispersing electrolytes into one or more polymer layers in the photorefractive device. In Examples 20 and 23, the grating decay time was 32 seconds. In Example 21, the grating decay time was as 11 seconds. However, in Comparative Example 9, the grating decay time was much longer than 300 seconds.

Although the foregoing description has shown, described, and pointed out the fundamental novel features of the present teachings, it will be understood that various omissions, substitutions, and changes in the form of the detail of the apparatus as illustrated, as well as the uses thereof, may be made by those skilled in the art, without departing from the scope of the present teachings. Consequently, the scope of the present teachings should not be limited to the foregoing discussion, but should be defined by the appended claims. All patents, patent publications and other documents referred to herein are hereby incorporated by reference in their entirety.

1. A photorefractive device, comprising:
a photorefractive material;
a first transparent electrode layer;
a first polymer layer interposed between the first transparent electrode layer and the photorefractive material; and
an electrolyte dispersed in said first polymer layers.

2. The device of claim 1, wherein the electrolyte comprises an organic salt.

3. The device of claim 1, wherein the amount of the electrolyte is in the range of about 0.01% to about 10% by weight of the first polymer.

4. The device of claim 3, wherein the amount of the electrolyte is in the range of about 0.1% to about 2% by weight of the first polymer.

5. The device of claim 1, further comprising a second polymer layer and a second transparent electrode layer, wherein:
the first transparent electrode layer and the second transparent electrode layer are positioned on opposite sides of the photorefractive material; and
the second polymer layer is interposed between the second electrode layer and the photorefractive material.

6. The device of claim 1, wherein the grating response time and grating decay time of the photorefractive device is reduced, relative to a photorefractive device containing a transparent electrode layer, a photorefractive material, and a polymer layer without an electrolyte interposed there between.

7. The device of claim 1, wherein the grating diffraction efficiency of the photorefractive device is increased, relative to a photorefractive device containing a transparent electrode layer, a photorefractive material, and a polymer layer without the electrolyte interposed there between.

8. The device of claim 1, wherein the grating response time of the photorefractive device is 3 seconds or less when measured by a laser beam.

9. The device of claim 1, wherein the grating decay time of the photorefractive device is 3 seconds or less when measured by a laser beam.

10. The device of claim 1, wherein the grating diffraction efficiency of the photorefractive device is five times stronger, relative to a photorefractive device containing at least one transparent electrode layer and a photorefractive material with a polymer layer interposed there between without electrolytes.

11. The device of claim 1, wherein each of the first and the second polymer layers independently comprises a polymer selected from the group consisting of polymethyl methacrylate, polyimide, amorphous polycarbonate, siloxane sol-gel, and combinations thereof.

12. The device of claim 1, wherein the electrolytes is selected from the group consisting of ammonium salts, heterocyclic ammonium salts, phosphonium salts, acridinium salts, and combinations thereof.

13. The device of claim 1, wherein the total thickness of the first polymer layer or the combined thickness of the first and the second polymer layers is from about 2 μm to about 40 μm.

14. The device of claim 13, wherein the total thickness of the first polymer layer or the combined thickness of the first and the second polymer layers is from about 2 μm to about 30 μm.

15. The device of claim 1, wherein the first electrode layer and/or second electrode layer each comprises a conducting film selected from the group consisting of metal oxides, metals, and organic films, wherein the conducting film has an optical density of less than about 0.2.

16. A method of improving a photorefractive device of claim 1, comprising interposing one or more polymer layers between a transparent electrode layer and a photorefractive material, wherein at least one of the one or more polymer layer comprises one or more electrolytes.

17. The method of claim 16, wherein the amount of the one or more electrolytes is in the range of about 0.01% to about 10% by weight of the polymer.

18. The device of claim 1, further comprising a second polymer layer and a second transparent electrode layer, wherein:
the first transparent electrode layer and the second transparent electrode layer are positioned on opposite sides of the photorefractive material; and
the second polymer layer is interposed between the first electrode layer and the photorefractive material.

19. The device of claim 5, further comprising a second electrolyte dispersed in the second polymer layer.
